(19) United States
(12) Patent Application Publication
(10) Pub. No.: US 2010/0156045 A1
(43) Pub. Date: Jun. 24, 2010

(54) PUZZLE AND GAME

(76) Inventors: Allyn Kahn, New Port Richey, FL (US); Patricia Corbett, New Port Richey, FL (US)

Correspondence Address: DENNIS G. LAPOINTE;LAPOINTE LAW GROUP, PL, PO BOX 1294, TARPON SPRINGS, FL, 34688-1294, US

(21) Appl. No.: 12/618,803

(22) Filed: Nov. 16, 2009

Related U.S. Application Data
(60) Provisional application No. 61/139,738, filed on Dec. 22, 2008.

(51) Int. Cl. A63F 9/00; A63F 9/24; A63F 13/00

(52) U.S. Cl. 273/153 R; 463/9; 463/30

(57) ABSTRACT

This invention has embodiments of a puzzle and game that can be enjoyed by adults and children. Each of the puzzles can be solved using either a writing surface, by means of a puzzle kit or by using a digital electronic devise. The games can be played using either a writing surface, by means of a game kit or by using one or more digital electronic devises. The present invention includes a learning method related to the puzzle invention that has many applications. In one embodiment, the method can be used to help someone improve their understanding of the game of chess.

### FIELD OF THE INVENTION

The invention relates to puzzles and games for children and adults.

### BACKGROUND OF THE INVENTION

“The essence of a successful puzzle is to arrive at a degree of difficulty which neither frustrates the user by being too difficult nor bores the user by being too easy to solve.” U.S. Pat. No. 4,189,151 to Klopfenstein issued Feb. 19, 1980.

Traditionally puzzles of the general type under discussion have two major values—the primary one being enjoyment and recreation, the secondary one being education, in particular the teaching of critical thinking and problem solving. It is now recognized that the process of solving puzzles has another important value, helping to develop new neural pathways in the brain thus aiding in the prevention of various brain conditions under the general category of dementia. Recent scientific studies have determined that learning new skills such as dancing, playing a musical instrument, learning a new language, and exercising the brain by solving various kinds of puzzles, even late in life, can help offset the deleterious affects of brain aging.

There are many programs being developed to provide systematic brain exercises. One such program: Change Your Brain, Change Your Life, by Dr. Daniel Amen, M.D., has been presented several times on Public Television during their periodic fund raising events. Another source for these types of brain exercises can be found in bookstores and airport convenience stores. Several different publishers sell magazines that each contain a variety of such puzzles. Dell Publishing and Penny Press are among the most popular publishers of these kinds of puzzle magazines, which include a new entry into this field known as Brain Boosters.

In terms of the skills and knowledge base required to arrive at a solution, puzzles can be classified under various types. Some puzzles require outside information in order to arrive at a solution. This is particularly true of crossword puzzles, which require knowledge of English and a huge general knowledge base. Cryptograms generally require knowledge of the structure of words and grammatical patterns, as well as knowledge of the statistical frequency of various letters. In addition cryptograms require the ability to apply logical suppositions and intuition, which make these kinds of puzzles more challenging.

Some puzzles require basic mathematical ability while others require the acquisition or deduction of certain techniques. Once these techniques are learned, the puzzles can be solved in a more or less routine way. These general remarks apply to puzzles such as Kakuro and Sudoku as well as a large class of logic puzzles that can be solved by setting up a table of the given and unknown information. One aspect of these puzzles is that after acquiring the necessary set of skills, each puzzle can be solved using the same general methods. Once these methods are mastered, there is nothing new to learn. As noted earlier, one of the main benefits of learning new skills, such as a new language or how to dance, is that learning these new skills creates new neural networks. Therefore, a puzzle that required the learning of new skills and that constantly presents new challenges would be very beneficial in this regard. In fact, these are the main advantages of our puzzle invention and its various embodiments.

Our puzzle and its various embodiments have several other advantages over the puzzles already mentioned. First the various embodiments of our puzzle are easy to learn. In some embodiments of our puzzle one needs only the knowledge of the English alphabet, which every child learns at a very early age. The puzzles are solved using logical methods without making reference to any kind of knowledge base. These methods include the well known and universally useful method of “trial and error.” However, the methods required to solve the more complex puzzles require a much more sophisticated set of methods. The solver of these more sophisticated puzzles is required to use methods such as the process of elimination, calculation along several branches, discovery of general deduction theorems, and educated guessing based on a rough statistical analysis. The strategies involved are similar to the thought processes involved in decision making when playing a game of chess. The advantage of this invention over chess is that in chess an extensive knowledge base is required as well as extensive training in order to be able to master the game.

In contrast with some other puzzles, once one learns the basic strategies of our puzzles, one can become quite skilled at solving the simpler puzzles relatively quickly. On the other hand when encountering the more sophisticated puzzles, various new skills need to be acquired for discovering the successful solution of our puzzles. In addition, in at least one embodiment of our puzzle invention, abilities and knowledge similar to that used in solving crossword puzzles is required. Therefore, our puzzle inventions have the potential to appeal to a wide spectrum of the population.

Another advantage of our puzzle is that the easier puzzles can be solved in a relatively short period of time, in some cases within a few minutes. Even some of the more difficult puzzles of our invention can be solved almost as quickly, if one arrives at the correct insight, or once the proper methods are understood. A related advantage is that if a mistake is made in the process of solving one of our puzzles, the mistake can be easily and quickly recognized and rectified and the solver can then try a different “path” toward the correct solution. In other types of puzzles such as crossword puzzles, cryptograms and number puzzles, one mistake can lead one to spend an inordinate amount of time pursuing a mistaken “path” in pursuit of the puzzle solution. If the initial mistake remains undiscovered by the puzzle solver, the correct solution to the puzzle is almost never found. This can be very frustrating to any puzzle solver, and particularly to someone less experienced or less motivated in solving puzzles, who may decide to abandon all attempts to solve that type of puzzle.

Given the complexity and diversity of the puzzles and associated games described here as part of our invention, there is a strong potential that once the puzzles that we have invented become popular, that entire books will be written on the solution methods, and that internet discussion groups will be formed for the sole purpose of examining and augmenting the various methods. Another possible outcome is that universities and public television networks will sponsor contests based on these puzzles, and mathematical dissertations will be written on the puzzles ramifications, due to their educational value and theoretical mathematical richness.

The properties of this puzzle and its various embodiments that make it different are as follows. First the puzzle is easy to learn as there are only a few rules, all of which are easy to understand. Second, the puzzles can be geared toward a wide variety of skill levels from the very easy to extremely difficult. Third, there is a wide variety of embodiments of the puzzles that we have invented that require one to learn new skills in order to solve the various embodiments of the puzzle. In addition the games that we have invented that are associated with the puzzle require skills that embody much of the strategic complexity of games such as chess, bridge and “Go,” without requiring the vast knowledge base that is associated with these traditional games.

A further advantageous aspect of the invention is that when the puzzle is solved, especially in the more complex embodiments, the completed solution in some instances has an artistic aspect. The logic of the puzzle provides the person observing the solution or the one who has solved the puzzle to note the “elegance” or “intrinsic logical beauty” of the solution. These or similar terms are reserved for particularly rare chess problems and compositions as well as a relatively small number of famous chess games such as the Evergreen Game of the 19^{th} century or Bobby Fischer's Game of the (20^{th}) Century versus Donald Byrne. However, in the realm of chess, a large amount of chess knowledge is required before one can fully appreciate the beauty of such examples. In our invention, one can experience this “beauty” after a relatively small amount of time spent on solving these kinds of puzzles.

The Puzzle and the variations and extended puzzles are of a type that would typically be found in newspapers and magazines on puzzle pages alongside crossword puzzles, cryptograms, chess problems and Sudoku puzzles. Books that contain the basic and extended puzzles are another likely medium for these Puzzles. The Games that are based on the Puzzles can be marketed and packaged like many other board games such as Monopoly and Clue. Some of the other versions can be marketed and packaged like three dimensional puzzles such as Rubik's Cube. Furthermore, all versions of the Puzzles and the Game versions can be made available in electronic versions, both as stand alone or hand-held puzzle and game modules and as an entire software package or part of a software package for personal computers. In addition all of these electronic puzzles and games can also be made available in online versions, for example where players could solve the puzzles, and play or compete with these puzzles and games over the Internet or using other forms of electronic digital media.

### A Method for Teaching Chess

The original goal for the puzzle invention was to find a method for teaching a sophisticated chess concept and decision making technique to young students. When considering a complex position in a game of chess there is a multifaceted method of analyzing a chess position, described in the well-known book “How to Think Like a Grandmaster” by Alexander Kotov. To use this method when making a decision about a move in a particular chess position, a player chooses between two to four “candidate moves” that the player wants to consider in detail. Using this candidate move method, the player then calculates the consequences of each candidate move separately, and makes an evaluation of the respective chess positions that result from each candidate move. These respective chess positions can be several moves beyond the original position. This method is sometimes referred to as a tree of analysis, since in making the calculations some candidate moves lead to further branches that need detailed analysis as well. A method for evaluating a chess position, which as part of this method occurs at the end of each branch of the analysis tree, is discussed in the detailed description below. Based on this analysis and multiple position evaluations, the player then chooses the chess move that produces the most advantageous position, and then makes that chosen move.

The present puzzle invention can be used to help students of chess better understand and implement the methods of choosing candidate moves and constructing an analysis tree.

### SUMMARY OF THE INVENTION

In accordance with this invention, one embodiment of the puzzle comprises a six by six Large Grid, containing thirty-six Cells, ten of which are Blanked Out, meaning they are not in use for this particular example of the puzzle. In this embodiment, the large grid is divided into nine Small Squares of four cells each. The puzzle solver attempts to place the twenty-six letters of the English alphabet into the available cells of the grid in accordance with a set of Puzzle Rules, which in this embodiment require the letters of the alphabet to be placed in alphabetical order adjacent to one another, with the additional constraints that once a letter is placed in one small square, that small square must be completed before placing letters in another small square and that when the puzzle is completed, no two vowels, including the vowel Y, may appear in a row or column of the grid.

In accordance with this invention, one embodiment of a game comprises a kit of game components, wherein the game provides a competition between two or more players who attempt to complete an example of the puzzle described in the above paragraph. Play of the game consists of players taking turns filling in one small square of the puzzle in accordance with the puzzle rules. Awards are given for Blocking ones opponent from making a letter placement that does not violate the puzzle rules, such action requiring a player to take back certain letter placements in order to attempt to complete the puzzle. Awards for other game events include but are not limited to pointing out a placement by an opponent that violates one of the puzzle rules and being the first player to successfully complete the puzzle. In addition to the puzzle and game inventions, this invention includes a method to improve ones practical results when playing a game of chess.

### BRIEF DESCRIPTION OF THE DRAWINGS

In the accompanying drawings, which are conceptual representation of the invention,

FIG. 1 shows the basic grid components of the puzzle invention;

FIG. 2 shows an example of one embodiment of the puzzle rules, puzzle and the puzzle solution;

FIG. 3 shows partial solutions of the puzzle in FIG. 2;

FIG. 4 shows a material embodiment of the puzzle that uses puzzle pieces in a puzzle tray;

FIG. 5A shows an embodiment of the puzzle using an alternate set of rules;

FIG. 5B shows the solution to the puzzle of FIG. 5A;

FIG. 6 shows an embodiment of the puzzle using non-uniform special sub-regions using the rules of FIG. 2, and the solution to the puzzle;

FIG. 7 shows another embodiment of the puzzle with an added word clue constraint, and the puzzle solution;

FIG. 8 shows an embodiment of the puzzle and the puzzle solution with several word clues;

FIG. 9 shows a different embodiment of the puzzle and a solution that uses numbers rather than letters and alternate puzzle rules;

FIG. 10 shows another embodiment of the puzzle and the solution, using an alternate set of rules about the diagonals of the puzzle grid;

FIG. 11 shows a different embodiment of the puzzle that uses the same set of symbols two times (this also relates to an embodiment of the game invention);

FIG. 12 shows the solution for the puzzle in FIG. 11;

FIG. 13 shows an embodiment of the puzzle using the alphabet four times (this illustration and the rest that follow also relate to various embodiments of the game invention);

FIG. 14 shows a different embodiment of the puzzle that uses pictures rather than using numbers, letters or symbols;

FIG. 15 shows an electronic device that contains one or more embodiments of the puzzle invention;

FIG. 16 shows another electronic device that contains one or more embodiments of the puzzle invention;

FIG. 17 shows an embodiment of the puzzle that uses a set of symbols rather than letters or numbers;

FIG. 18 shows a different embodiment of the puzzle that uses a set of numbers and a different set of rules, and which has the property that the cells of the grid and the special sub-regions are not of uniform size and shape as well as shows the solution to the puzzle;

FIG. 19 shows an embodiment of a game and associated rules based on one embodiment of the puzzle; and

FIG. 20 shows a schematic diagram that depicts a method for teaching chess that relates to the puzzle invention.

### DETAILED DESCRIPTION OF INVENTION

The present invention is described below by reference to the aforementioned drawings.

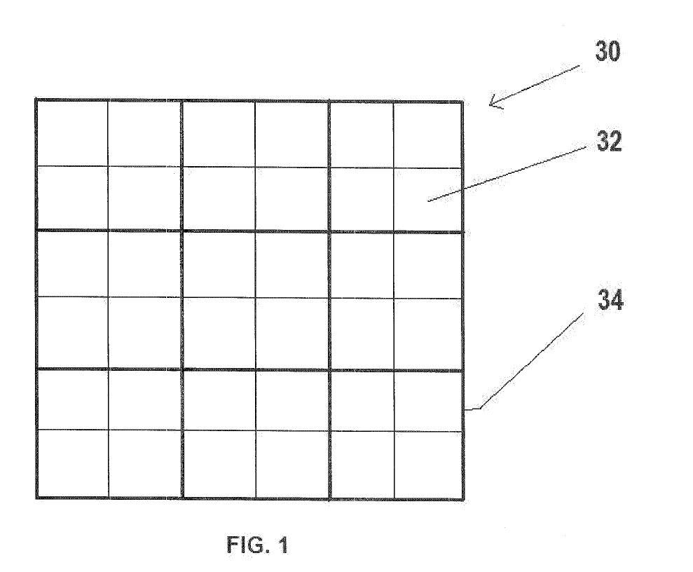

FIG. 1 shows the basic components of a puzzle, showing a Puzzle Grid 30, one cell 32 of the thirty-six cells of the grid where puzzle solver places a letter, number or symbol as part of the process of solving the puzzle, and one of the nine special sub-regions of the grid, which is in this case a Square 34 comprising four cells.

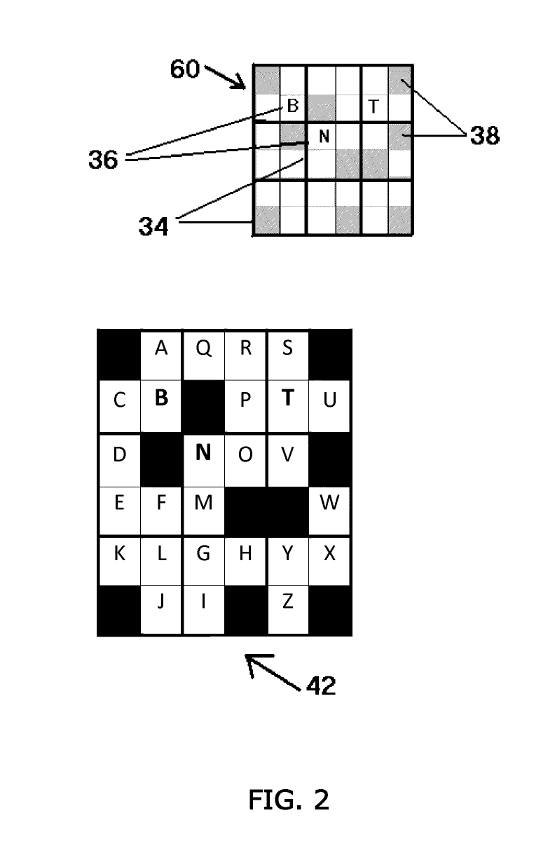

FIG. 2 shows an example of one embodiment of a puzzle with an enumeration of a set of rules:

The object is to complete the grid by placing each of the letters of the alphabet in order, starting with the letter A, one letter in each cell, while following all of the four rules listed below.
Rule 1: Each new letter that you list must be either next to, directly above, directly below or on a diagonal that is adjacent with the previous letter. [ADJACENT RULE]
Rule 2: Letters are already filled in that you must use. [GIVEN LETTER RULE]
Rule 3: When filling in successive letters, once you place a letter in a new 2×2 Square, you must finish filling in that square before placing a letter in a new square. [SQUARE RULE]
Rule 4: When all the letters are filled in, the vowels (A, E, I, O, U, and Y) must be placed so that no two vowels are on the same row or column. [VOWEL RULE]
The Puzzle Grid shows two of the nine small Squares 34, one in the middle of the grid and one in the lower left hand corner, two of the three Given Letters 36. Also shown are two of the ten blanked out cells 38, which means that these cells are not available for placement of any letters, numbers or symbols, and a set of instructions and rules above to be used to solve the puzzle. These four basic rules are referred to as the Adjacent Rule, Given Rule, Vowel Rule and Square Rule. As will be seen, other embodiments of the puzzle and related games may or may not require all of these rules or may contain modifications of or additions to the above rules.

The solution to the puzzle 42 is also shown. Notice that one can easily check that one has a true solution. Beginning with the letter A, one can point to the next letter of the alphabet and see that each new letter is adjacent to the previous one [Adjacent Rule]. It can also be seen that when going through the alphabet, each two by two square is completed before a new square is used. [Square Rule] We also see that the given letters, in this case B, N and T are in their proper places with respect to the rest of the alphabet. [Given Rule] Finally, there is an easy way to see that no two vowels are on the same row or column. [Vowel Rule] One simply needs to visually scan down each column and across each row to see that there is exactly one vowel on each row and column. Therefore all four puzzle rules 40 have been followed and the puzzle solution 42 in FIG. 2 is correct. In this case it is also the only possible solution to the puzzle 60 in FIG. 2.

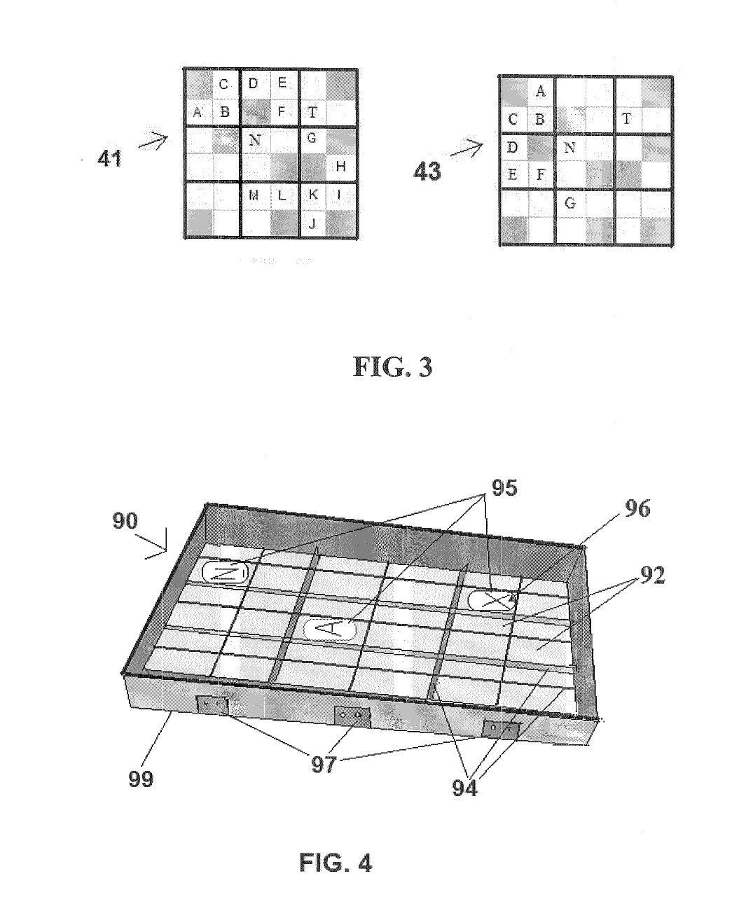

In the process of attempting to find a correct solution to the puzzle in FIG. 2, one can take many approaches, some of which will not yield a correct solution. One such attempt is shown 41 in FIG. 3. The reasoning behind this attempt is explained below with reference to FIG. 3. One of the most obvious ways to try to solve this type of puzzle is to begin by deciding where to place the letter A. Looking at the unsolved puzzle 60 in FIG. 2, we see that the letter B numbered 36 is already a given letter that is in the puzzle grid. Due to the adjacent rule and given rule, the A must be adjacent to the letter B that is already given. Thus to also follow the square rule, there are only two choices for the letter A: the letter A must be in the cell either to the left of or above the given letter B. We begin with the first choice.

If one starts by placing the letter A to the left of B, the next letter C can only be above the letter B by the square and adjacent rule. Again by the adjacent rule, D must be to the right of C in the square to the right of the upper left hand corner square. Now by the square rule E must be either to the right of D or on the diagonal below D. But the second choice violates the vowel rule as that choice would put both A and E on the second row. Therefore E must be to the right of D and by the square rule F must be placed below E.

By the given and adjacent rules, the only logical place for the letter G is below the given letter T. By the square rule, the letter H must be in the diagonal to the right of G. Because of the adjacent and square rules, the letters I, J and K must be placed in the lower right corner square. There are a number of ways that these three letters can be placed in this square. All of the ways that make any sense in terms of the rules, force the next letter L to be in the only cell available, the cell to the left of that lower right corner square. This forces the letters M and N to be placed in the lower middle square. But N is already in the puzzle grid as a given letter, so it cannot be placed a second time in this puzzle. Therefore, once the letter M is placed we are “blocked” 41. We use the term blocked in many of the embodiments of the puzzle invention to indicate a situation in which there is no letter, number or symbol placement available in a puzzle grid that does not violate at least one of the puzzle rules.

Going back to how the attempted solution was begun, we see that the initial cell choice for the letter A led to the problem of being blocked. Moreover, once the letter A was placed in the cell to the left of the letter B, all of the other letter placements (except for I, J and K) were the only ones possible without violating the puzzle rules. Therefore, since the letter A cannot be in the cell to the left of the letter B, there is only one other choice. The letter A must be placed above the letter B. By following the rules 40 in FIG. 2 and using reasoning similar to that shown above, one can eventually arrive at the partial solution 43. At that point it is not immediately clear where the letter G needs to be placed. Continuing to reason in a manner similar to that shown above, one eventually arrives at the correct solution to the puzzle 42 shown in FIG. 2. More details on the further reasoning for this particular example can be found at the end of this section.

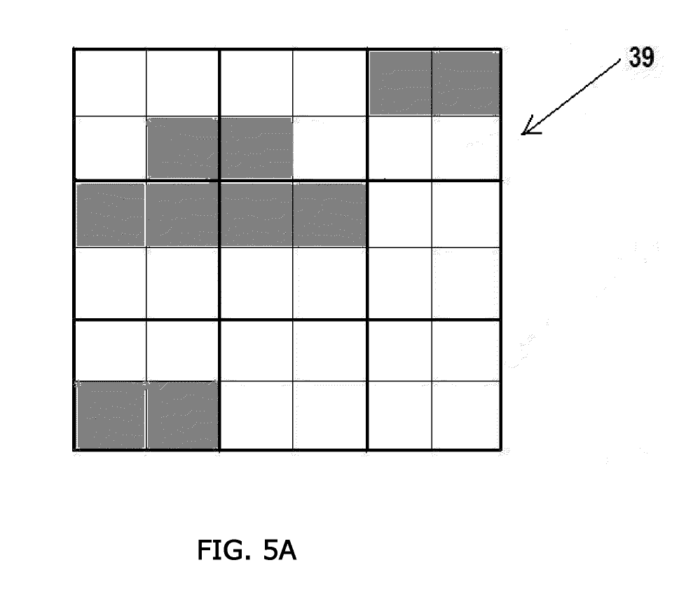

FIG. 4 shows one embodiment of a puzzle kit that includes a number of puzzle pieces 95, each of which contains a printed symbol 96. The puzzle solver places each of the puzzle pieces in a cell or compartment 92 that are in the puzzle tray 90. The puzzle tray comprises material that defines the puzzle grid using permanent or removable partitions 94 for the purposes of containing the puzzle pieces. The puzzle tray may employ a set of hinges 97, that allow for the bottom of the tray to move so that a puzzle example that has a puzzle grid printed on a stiff puzzle board can be inserted in the bottom of the tray so that it faces up towards the user of the puzzle, so that the user may replace one puzzle example with another in order to solve a variety of puzzles.

Alternatively, the bottom of the puzzle tray may consist of a transparent material such as PLEXIGLAS® material and a slot that extends along the entire bottom of the game tray so that various puzzle boards can be inserted so that different puzzle examples can be solved.

A puzzle kit can also be constructed, comprising a white board or similar erasable device using writing devices such as pencils or erasable white board markers to place letters, numbers or symbols in a puzzle grid. In another embodiment the puzzle kit can consist of a metal game board with magnetic puzzle pieces or magnetic tiles that are imprinted with puzzle letters, numbers or symbols.

Each of the puzzle kits described can also be used for a game played by two or more players. One embodiment of the game invention is played as follows. A round of play consists of two or more players competing to complete the same puzzle by placing letter tiles 95 one at a time in the puzzle tray 90 like the one depicted in FIG. 4. Each player takes turns placing one or more letters until that player completes placement for all the cells in a particular square, a square in this puzzle embodiment consisting of four cells. The first player to place the last letter Z in a cell in a way that correctly completes the puzzle solution wins that round of the game. The winner of the game is the player who has won the most rounds after a pre-determined number of rounds have been played.

In another embodiment of the game invention, play proceeds as described above with the following additional rules. If on a player's turn that player is not able to fill all the unfilled cells in a square, in other words that player is blocked, then they lose a set number of points, the number being pre-determined by the particular rules of the game. The player who played previously and caused the next player to be blocked, is awarded a set number of points. The player who was just blocked then removes a number of letter tiles of their choosing. Then the next player takes their turn. Play continues in this manner until the round ends. The round ends when either the puzzle is completed or one of the players reaches a score number that is pre-determined by the rules of the game. After a certain pre-determined number of rounds are played the player with the highest score is declared the winner of the game. Alternatively, the winner is the first player to reach a certain number of points.

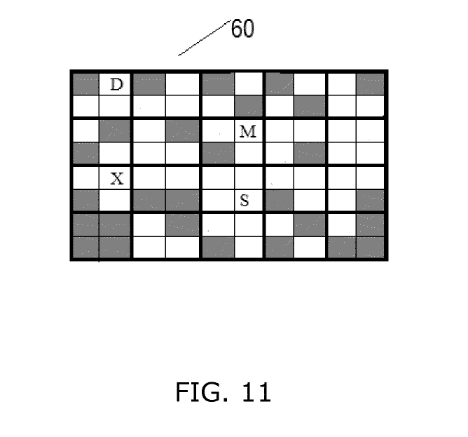

Other embodiments of the game invention are also within the scope of this invention. Any number of games similar to the one described above can be played using the game kit described in FIG. 4 or using a different game kit. Any of the game inventions described herein can also be played using one or more erasable writing surfaces. Another game embodiment with different rules, but still within the scope of this invention is described below with reference to FIG. 11.

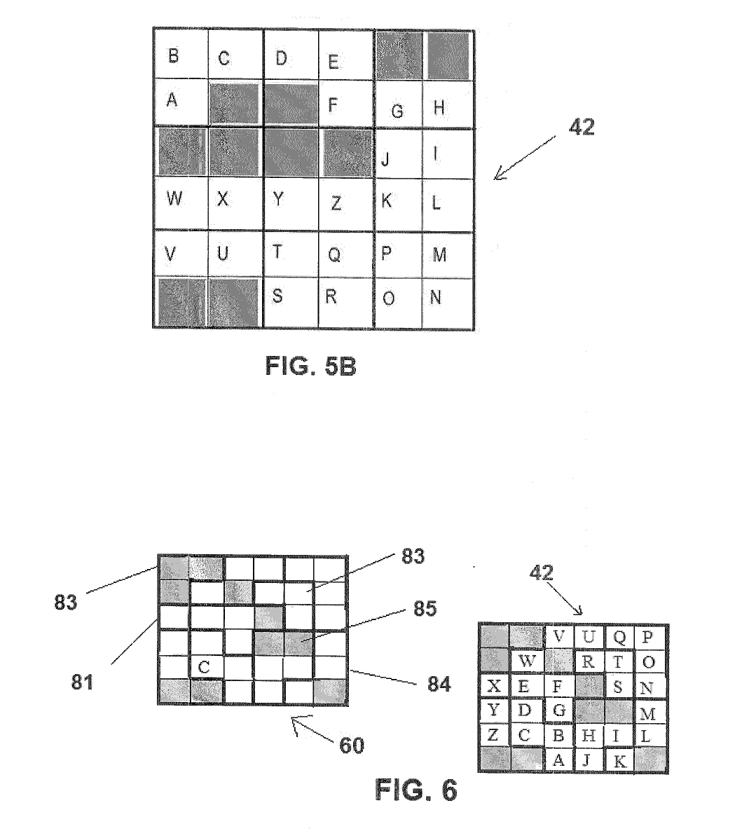

FIG. 5A shows another embodiment of the puzzle 39 using letters. The list of Puzzle Rules contains a restricted adjacent rule in which letters follow a horizontal or vertical path, but not a diagonal path.

The object is to complete the grid by placing each of the letters of the alphabet in order, starting with the letter A, one letter in each cell, while following all of the three rules listed below.
Rule 1: Each new letter that you list must be in a cell that is either next to, directly above or directly below (but not on a diagonal cell) the cell of the previous letter. [RESTRICTED ADJACENT RULE]
Rule 2: When filling in successive letters, once you place a letter in a new 2×2 Square, you must finish filling in that square before placing a letter in a new square. [SQUARE RULE]
Rule 3: When all the letters are filled in, the vowels (A, E, I, O, U, and Y) must be placed so that no two vowels are on the same row or column. [VOWEL RULE]

Note that in this particular puzzle there are no given letters. Therefore there is no given rule. This embodiment of the puzzle invention and any other embodiment that falls within the scope of this puzzle invention can be used as part of a game played by two or more players.

FIG. 5B shows the correct Solution 42 to the puzzle in FIG. 5A. As in the description relating to FIG. 3, one can easily check that the solution is correct by pointing to each letter of the alphabet, beginning with the letter A to show that the letters are adjacent according to the restricted adjacent rule (Rule 1 in FIG. 5A). Similarly one can see that the square rule and the vowel rule are followed, as described in the description relating to FIG. 3.

FIG. 6 shows an embodiment of the puzzle with the same rules as the rules for the puzzle in FIG. 2. In this case however, the puzzle 60 has the property that the special sub-regions, which in the previous puzzles were known as squares, are not of uniform shape or size. The special sub-regions are each outlined in the puzzle grid by heavy lines. One special sub-region 81 has only one cell. Exactly two special sub-regions consist of three cells each 83. One special sub-region has five cells 85. The remaining special sub-regions, like the one shown 84 each consist of exactly four cells, yielding a total of ten sub-regions. Notice that there is one given letter. The solution 42 to this puzzle is shown. As with previous solutions this puzzle solution can be checked for accuracy by using the methods described above.

The solution to the puzzle 60 in FIG. 6 can be used to describe another embodiment of the puzzle. In this embodiment all the letters of the solution 42 or a subset of the letters of the solution are imprinted on a piece of wood, plastic or other suitable rigid material. The material is then cut along the heavy lines of the special sub-regions of the puzzle 60 to make a new type of jig-saw puzzle. In this example each jig-saw puzzle piece corresponds to one of the ten sub-regions, 81, 83, 84, 85, of the puzzle. The solver of the puzzle would begin by examining the ten separate puzzle pieces with the puzzle solution 42 imprinted on the jig-saw puzzle pieces either partially or completely. The task for the puzzle solver is to place the puzzle pieces adjacent to one another in their proper position and orientation, to form the correct solution 42. In the case where the solution is printed partially, the solver may also have the task of writing the correct letters in the remaining cells of the puzzle.

In another embodiment, the ten pieces are virtual pieces in an electronically generated puzzle in a digital application that can be solved by manipulating the virtual pieces on a portable phone, PDA, gaming device, computer screen or similar device, using various computer commands, or by means of gestures such as those available on a touch screen device like the I-Pod Touch®.

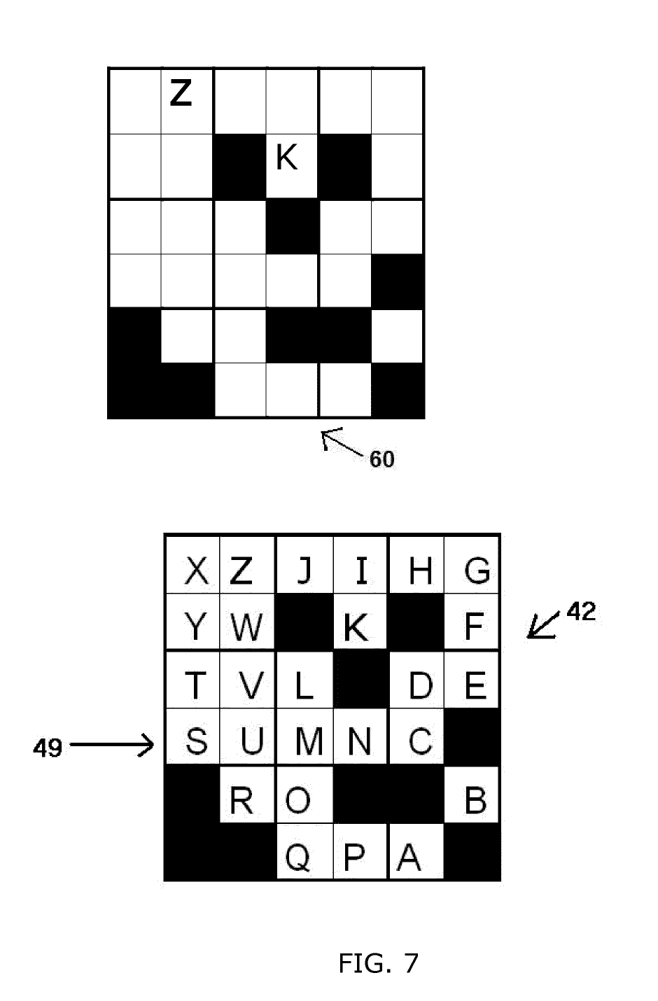

FIG. 7 shows an embodiment of the puzzle that has three of the four rules of the puzzle of FIG. 2.

To solve the above puzzle, complete the grid by placing each of the letters of the alphabet in order, starting with the letter A, one letter in each cell, while following all of the four rules listed below.
Rule 1: Each new letter that you list must be either next to, directly above, directly below or on a diagonal that is adjacent with the previous letter. [ADJACENT RULE]
Rule 2: Letters are already filled in that you must use. [GIVEN RULE]
Rule 3: When all the letters are filled in, the vowels (A, E, I, O, U, and Y) must be placed so that no two vowels are on the same row or column. [VOWEL RULE]
In addition to the above rules, there is the following added Rule.
The word that is indicated by the Word Clue must appear in the Solution to the Puzzle. The letters of the clue word must be adjacent to each other in a horizontal, vertical or diagonal line, in either the forward or backwards direction.

### Word Clue: “Result of Addition”

This embodiment does not require the square rule, but it has an added Word Clue constraint. The added rule states that the word that is indicated by the word clue must appear in the solution 42 to the Puzzle. The letters of the word must appear in the proper order of the word that is indicated by the word clue, and be adjacent to each other in a horizontal, vertical or diagonal line, in either the forward or backwards direction. Note that the solution to the above puzzle is more difficult than the puzzle in FIG. 2 as there are only two Given Letters: ‘K’ and ‘Z’. Moreover, in the process of solving this puzzle, it is possible to arrive at many “near solutions” that the solver of the puzzle does not recognize as incorrect solutions until she or he places some or almost all the letters in an attempt to complete the puzzle.

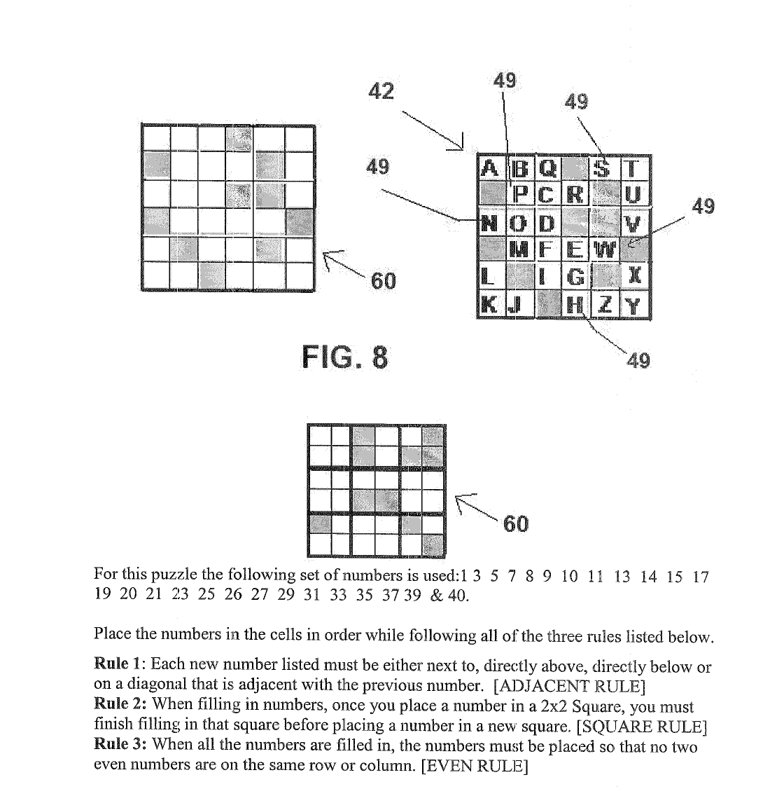

Notice that the solution 42 to the puzzle in FIG. 7 has the clue word 49, namely the word ‘SUM’ shown in the puzzle. Also notice that in this embodiment of the puzzle that the solution to the puzzle does not require using the square rule, which was required in the puzzle in FIG. 2. Other embodiments are possible that use word clues, such as the example shown in FIG. 8 below.

The puzzle 60 in FIG. 8 uses only one of the four rules that were used in the puzzle in FIG. 2, that is, the Adjacent Rule. In this puzzle, the Vowel Rule is not used. Notice that in the solution 42, the vowel rule would be violated as there are two vowels, the vowels U and Y, in the last column of the puzzle grid. The solution to the puzzle 42 has five clue words 49, going clockwise from the top: mop, us, few, him, and nod. In a puzzle with this embodiment, the actual clue words can be given explicitly as part of the puzzle. Notice that the clue words can appear either left to right, right to left, up, down or on a forward or backward diagonal.

Notice that since this puzzle has no given letters, the puzzle is considerably more difficult. There are also five added word clues that are not shown. Without these word clue requirements there are actually many solutions to the puzzle. In some embodiments of the puzzle, there is a requirement to find or construct all possible solutions. This task can be quite challenging and is meant for the more advanced puzzle solver.

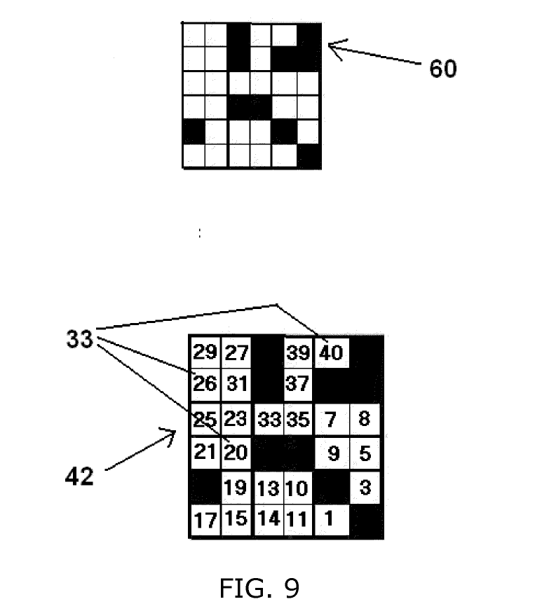

FIG. 9 shows an embodiment of the puzzle 60 that uses numbers rather than letters. Note that in this embodiment of the puzzle there are no given numbers. The list of numbers that must be used is given as part of the rules of the puzzle.

For this puzzle the following set of numbers is used:

1 3 5 7 8 9 10 11 13 14 15 17 19 20 21 23 25 26 27 29 31 33 35 37 39 & 40.

To solve the puzzle one must place the numbers in the cells in numerical order while following all of the three rules listed below.
Rule 1: Each new number listed must be either next to, directly above, directly below or on a diagonal that is adjacent with the previous number. [ADJACENT RULE]
Rule 2: When filling in successive numbers, once you place a number in a 2×2 Square, you must finish filling in that square before placing a number in a new square. [SQUARE RULE]
Rule 3: When all the numbers are filled in, the numbers must be placed so that no two even numbers are on the same row or column. [EVEN RULE]
Notice that there is no given rule as there are no given numbers. The adjacent rule and the square rule are the same as in previous embodiments of the puzzle invention, except that these rules now refer to numbers rather than letters. There is a new rule, the Even Rule, which requires that no two even numbers appear on the same row or column. This rule is similar to the Vowel Rule for embodiments of the puzzle that use letters. Notice that in the puzzle solution 42 shown, each of the six even numbers in the list of numbers appears exactly once in each row and column. Three of the even numbers 33, the numbers 20, 26 and 30 are indicated. The other three even numbers are 8, 10 and 14.

In another variation of this puzzle embodiment there is an additional Rule 4: No two even numbers can be adjacent to each other. [ADJACENT EVEN RULE] In still another embodiment this Rule 4 replaces Rule 3 in FIG. 9.

Of course other sets of numbers may be used for different embodiments of the puzzle invention. Different criteria other then even numbers can be used if a special subset of numbers is used. For example the special set could be only odd numbers, prime numbers, or prime numbers that are not members of a set of twin primes. In another embodiment of a puzzle that uses numbers the set of numbers used contains thirty-six numbers and there are no blanked out cells. Other embodiments of this puzzle invention that are not shown use different size grids, some of which are not uniform in shape. In some of these puzzles there are no given letters, while in some examples there are non-uniform special sub-regions, while in others there are no special sub-regions. Moreover, as stated before, this number puzzle and various related embodiments can also be used as the basis for a two or more player game.

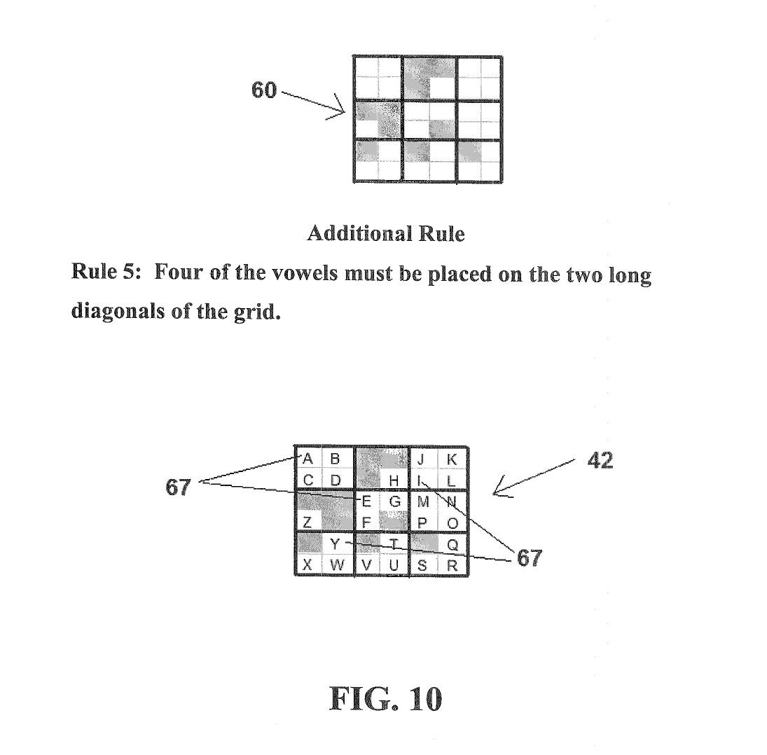

FIG. 10 shows an embodiment of a letter puzzle 60 with the same rules as the puzzle in FIG. 2, namely the Adjacent, Square, Given and Vowel rules, along with an additional fifth rule, the Diagonal Rule. This rule states that four of the six vowels must be placed on the two long diagonals. These are the two diagonals, one that begins with the upper left corner cell and extends down to the lower right cell, and the other diagonal that begins on the upper right corner cell and extends down to the left lower corner cell. In some embodiments of this puzzle, the puzzle grid uses color to highlight the diagonal cells. Notice that the solution 42 to the puzzle in FIG. 10 has the two vowels A and E on the first long diagonal mentioned, and the vowels I and Y on the other long diagonal 67. Although the given rule is part of the puzzle rules for this embodiment, in this example there are no given letters.

In another embodiment of the puzzle invention that is not shown, there is a different rule requiring that no vowels appear on the long diagonals of the grid.

FIG. 11 shows an embodiment of the puzzle 60 that uses the same set of symbols, in this case the Standard English alphabet, two times. This is a more challenging puzzle in that the solver must place the letters in two interlocking paths in conformity to a larger set of rules and constraints:

The object is to complete the grid by placing each of the letters of the alphabet in order, two times, starting with the letter A, one letter in each cell, while following all of the six rules listed below.
Rule 1: Each new letter that you list must be either next to, directly above, directly below or on a diagonal that is adjacent with the previous letter. [ADJACENT RULE]
Rule 2: Letters are already filled in that you must use for one of the two alphabets. [MODIFIED GIVEN RULE]
Rule 3: When filling in successive letters, once you place a letter in a 2×2 Square, you must finish filling in that square before placing a letter in a new square. [SQUARE RULE]
Rule 4: When all the letters are filled in, the vowels (A, E, I, O, U, and Y) must be placed so that no more than two vowels are on the same row or column, and there is at least one vowel in each row and column. [MODIFIED VOWEL RULE]
Rule 5: There can be no repetition of any letter on any row or column. [REPEAT RULE]
Rule 6: When both alphabets are complete, the A in each alphabet must be adjacent to the Z in the other alphabet. [END RULE]
The puzzle grid is larger than previous ones shown, eight by ten cells for a total of eighty cells. Twenty-Eight cells are blanked out, that is, not available for placement of a letter. This leaves (80-28=52) exactly fifty-two cells left for placement of letters, that is, so that each letter of the alphabet appears twice in the puzzle grid.

Notice that the last three rules, Rules 4, 5 and 6, add a new level of difficulty to the puzzle. Rule 4, the Modified Vowel Rule, requires that no more than two vowels are on each row and column. Rule 5, the Repeat Rule, requires that no letter repeats in any row and column. Rule 6, the End Rule, requires that each A in an alphabet is adjacent to a Z in a different alphabet.

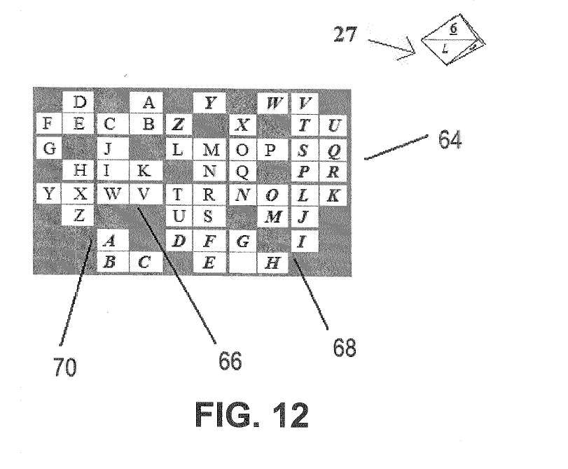

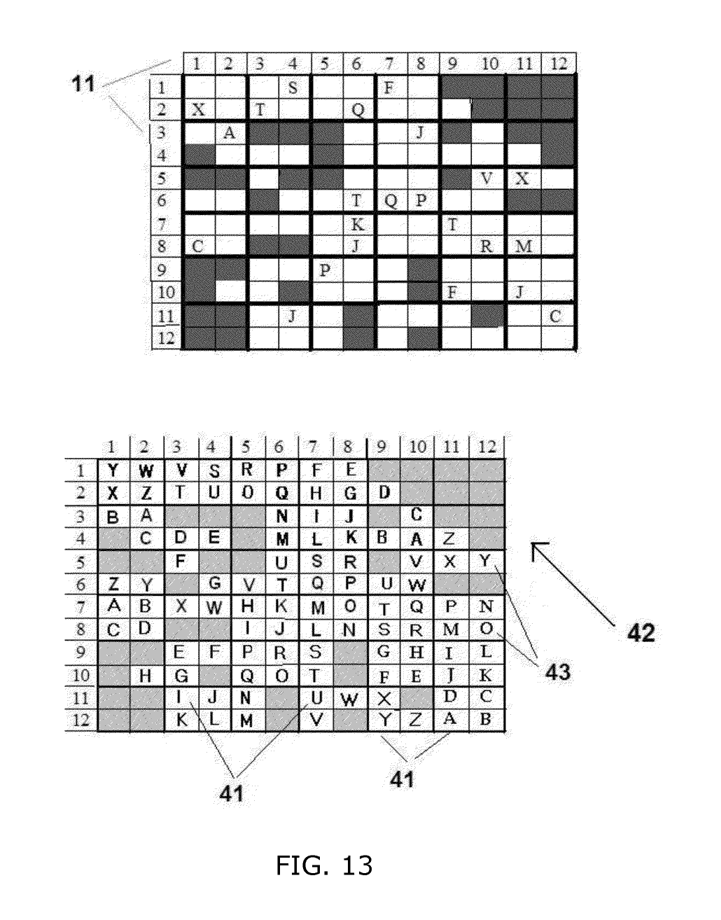

The puzzle shown in FIG. 11 can also be used for a game played between two or more players. Details of one embodiment of a game are covered in the explanation for FIG. 12.

FIG. 12 shows a correct solution 64 to the puzzle 60 in FIG. 11. In order to distinguish between the two alphabets one alphabet uses a standard font 66, while the second alphabet uses an italics font 68. Note also that because of the new end rule, that the ‘A’ of one alphabet is adjacent to the ‘Z’ of the other alphabet 70. In any of these and other embodiments of the puzzle invention the solutions may or may not be unique.

One embodiment of this invention relates to a game played by two or more players that uses a puzzle like the one shown in FIGS. 11 and 12. In the game played by two players, the puzzle board contains one or more of the first letters of the respective alphabets, one alphabet with the standard font and the other one with the italics font. The two alphabets may also be depicted in two distinct colors. An embodiment of the game may also be played using a game kit like the one shown in FIG. 4 that includes tiles with letters 95, a game tray 90 that contains a number of partitions that are appropriate for the size, shape and configuration of the puzzle game, with a means to replace puzzle boards in the bottom of the puzzle tray.

At the start of a round of the game players would each toss the eight-sided die 27 shown in FIG. 12. Using this die, or some other randomizing devise, allows the element of luck to enter into the game. Several other embodiments of the game use other random methods, such as choosing a card at random from a deck. These cards indicate some event of the game such as skipping a turn, placing a letter, number or symbol in a particular sub-region of the puzzle grid specified on the card or some other game-related event.

In the present game, the player with the highest score after tossing the eight-sided die begins the game by tossing the eight-sided die again. The number that turns up (from 1 to 8) on this toss tells the player the number of letters that player can attempt to place. For example, if the player of the red letters goes first, and tosses an 8, and only a red A was shown, then that player can place up eight letters, up to the red letter I (the 9^{th} letter) into the puzzle grid or the game tray. The round of play continues with each side taking turns tossing the die and placing letters of their own color on the puzzle board until either one player is blocked, one player makes a placement that violates the puzzle rules and the other player points out the rule violation, or one player completes their alphabet. Awards are given for each of these events. Play continues through one or more rounds based on predetermined criteria such as reaching a certain number of awards or a particular score, or based on a predetermined number of rounds or similar criteria.

In some embodiments of this game two or more types of tiles are used. The different types of tiles may be either constructed to contain different colors, different shapes, such as other geometric shapes, or easily distinguishable sizes, or any combination of the above. One use for these differences in one embodiment of the game requires each player to receive one of these distinct sets of tiles as their own for the purpose of scoring points for their tile placements. In some embodiments of this game the different tiles are used to indicate the intention of one player to double the stakes. That is, one player may declare or imply that they foresee that they will be the player who will successfully complete the puzzle, or achieve some other game event. Upon such declaration the other players may choose to continue the play of that round while risking the awards for said event to be double their original value. Or one or more of the other players may drop out of the round, causing a different set of scoring procedures to take place as predetermined by the written game rules and instructions.

In another version of a two or more player game, a game board or game template is provided in which each player has their own puzzle to complete within the same game board so that the respective puzzles interconnect or interlock. A turn by one player would be considered completed if one of the following events occurred: one player successfully completing a puzzle or one player having been ‘blocked.’ Play would then proceed to the next player, who attempts to place as many letters as possible on his or her interlocking puzzle. Points are awarded to players based on various events such as ‘blocking’ another player or causing another player to be blocked one or more times, or placing more letters than another player on the game board or completing their own puzzle. The ‘round’ of the game is considered finished when all players are blocked or at least one player has completed their puzzle. Respective scores are tallied at the end of each round. The winner of the game is the player who reaches a predetermined score, or the player who has the highest score after a predetermined number of rounds are played.

Many other game and puzzle embodiments that fall within the scope of this invention are possible.

FIG. 13 shows an embodiment of the puzzle that uses the same set of symbols, in this case the Standard English alphabet, four times. The puzzle grid is twelve by twelve, for a total of one hundred forty-four cells. Reference numbers 11 are shown in order to keep track of the cells and name them if necessary. Using four alphabets requires (4×26=104) one hundred four cells to be available for letter placements, which means that forty cells are blanked out. The rules are the same as for the puzzle described for FIG. 11. Because there are a total of (4×6=24) twenty-four vowels in the present embodiment, the Modified Vowel Rule that requires that no more than two vowels appear in each row and column actually results in exactly two vowels appearing in each row and column when one has the correct solution.

Notice that in the solution shown 42 the last two rows have their two vowels indicated, 41, namely the letters I and U in the next to last row, and the letters Y and A in the last row. Similarly, the last column has the two vowels Y and O 43. In some embodiments the four different alphabets are depicted using different colors. Clearly, this puzzle is much more difficult to solve than one with only thirty-six cells and one alphabet to work with.

One embodiment of a game associated with the puzzle shown in FIG. 13 has rules similar to the game associated with the puzzle in FIG. 11. In this embodiment, players may want to have the option of playing only one round. In order for this game to not become too long, one embodiment incorporates a timing device to limit the amount of time each player has to complete their turn. This timing option is also available for any other embodiments of the game invention.

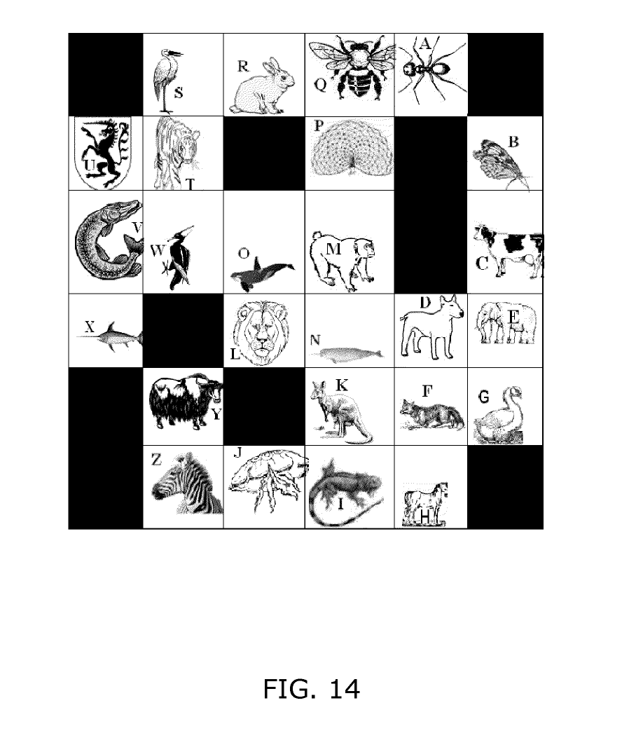

FIG. 14 shows a puzzle that uses pictures rather than numbers, letters or symbols. This embodiment, which contains pictures of animals and the beginning letter of each animal name, is designed to appeal to young children. The pictures could be placed on tiles as described in FIG. 4. The solution to a sample of a children's puzzle is shown. Again there are many possible embodiments that fall within the scope of this invention. In another embodiment in which there is no order assigned to the animals shown in FIG. 14, players take turns placing pictures of animals according to a specified criteria, such as zoo animal or farm animal, mammal or reptile, flying, land or marine animal, or other categories, where the special sub-regions correspond to a particular animal category. For games that are meant to appeal to children, the adjacent rule and the square rule can be suspended. Rather than animals, some other life form, such as flowers, butterflies, insects, reptiles, or similar categories could be used. In fact the scope of the game invention can encompass many types of objects or classes of objects.

The actual embodiment of the puzzle associated with this solution can vary depending on the level of difficulty desired. For children at the very elementary level the actual puzzle would contain about half of the animal pictures as given letters, as described in the Given Rule. There would be no rule about special sub-regions, such as the square rule. Children solving the puzzle would merely have to place the remaining pictures in proper alphabetical order according to the names of the animals. At a higher level this example of the puzzle or a similar example could contain the animal pictures but without the letters on the picture tiles. At a level for older children the puzzle could also contain a rule for special regions such as the square rule as described in FIG. 2.

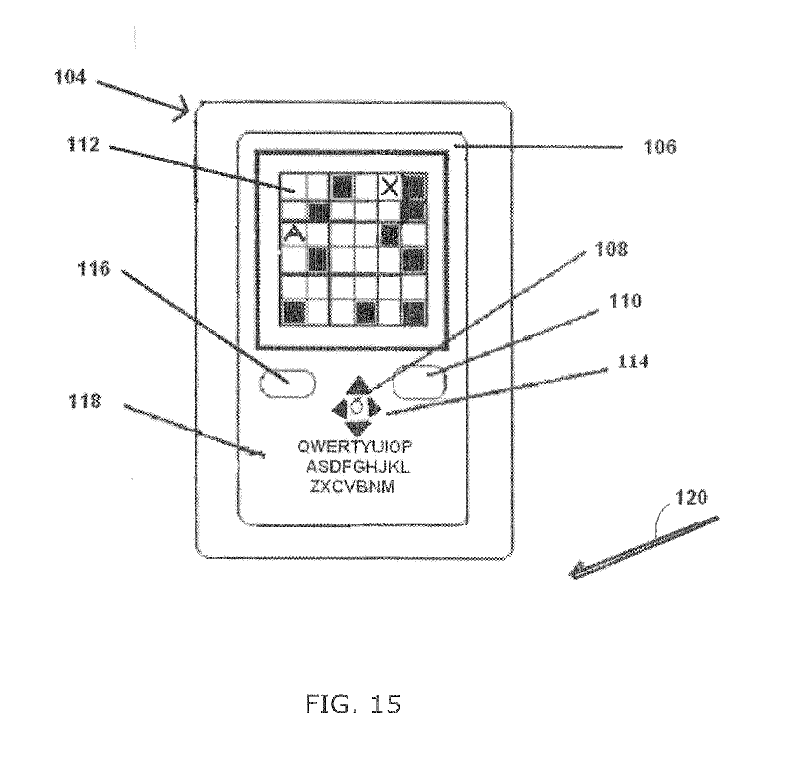

FIG. 15 shows an electronic device 104 that can be a Personal Computer, Laptop Computer, PDA, MP3 player, cell phone, stand alone puzzle device or other electronic device containing one or more embodiments of the puzzle invention, with a display screen with or without a touch screen option 106, showing a puzzle grid 112, and various controls such as a menu key 108 that could be used to choose the level of difficulty, start a new puzzle, or other command, back and delete keys 110, a select or highlight key 116, navigation keys 114 that allow one to go to any cell in the puzzle grid, a set of letter, number or symbol keys 118 that allow one to choose a letter, number, or symbol, and a stylus 120 that can be used on the touch screen or to operate the controls of the electronic devise. Given the invention puzzle parameters, a programmer skilled in the art can provide the necessary computer processing operating software for the device 104.

Other configurations of control buttons and menus are possible and fall within the scope of this puzzle and game invention.

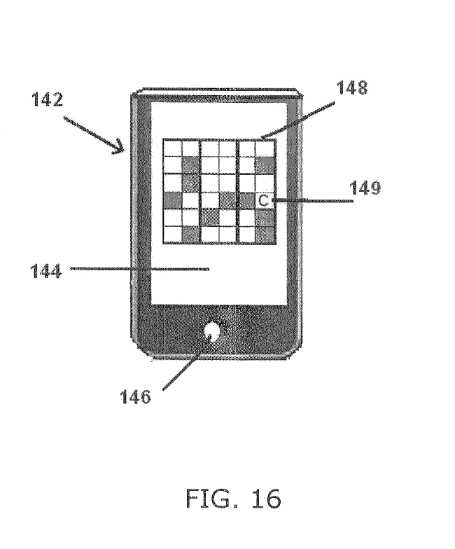

FIG. 16 shows an electronic device 142 that can be a Personal Computer, Laptop Computer, PDA, MP3 player, cell phone, stand alone puzzle device or other electronic device containing one or more embodiments of the puzzle invention 148 that can be displayed on the digital screen 144 of the device, along with a control device such as a scroll control 146, and alternately a method whereby the electronic devise is designed so that a puzzle may be solved by tilting the device with ones hand 140 or other appendage, which causes a virtual object 149 to move from one part of the puzzle grid to another in the process of solving the puzzle. Controls may or may not be available to turn on a sound or light indicator that signals the user if a correct or incorrect move of the virtual object has been carried out. The electronic device may also contain ways to turn on or off other such indicators as are available in the current state of the art. Given the invention puzzle parameters, a programmer skilled in the art can provide the necessary computer processing operating software for the device 142.

Controls depicted in the above described electronic devices can in many embodiments of the puzzle invention and the game inventions described below have a number of different functions. In some embodiments the menu control can be used to choose which of several types of puzzles or games is to be played, as well as the size and shape of the puzzle grid. In some embodiments, a back button can be used to take back one placement of a letter or any number of letter placements. There can also be a control to “lock in” a particular placement of letters while exploring a particular option of placements.

Another use of control buttons or menu-driven commands may be used to turn on or off certain functions that assist the player in solving the puzzle. These help functions may include hints, indicators that flash the next correct letter, number or symbol placement, or that warn a player when they are about to make a letter, number or symbol placement that will lead to a blocked situation. There are other many possible uses for the menu and various control buttons not mentioned here that fall within the scope of this invention.

Electronic devices like those described or that have other features not shown can also be used for one or more embodiments of the game invention. In one embodiment, two or more players would have state of the art game controllers that would allow each player to place letters, numbers or symbols on an electronic screen that depicts a puzzle grid. Game embodiments with rules as described above can be played in which players use the game controllers to place letters, numbers or symbols on the electronic grid.

In fact for many of the embodiments of the puzzle or game inventions the use of electronic devices provides convenience and flexibility. In one game embodiment each player has their own electronic devise as shown in either FIG. 15 or FIG. 16. The first player takes a turn by placing letters in one square of the thirty-six cell grid, using the rules shown in FIG. 2. By having a means of wireless or non-wireless communication between the electronic devices of the players of the game, the placement of the letters placed by the first player can be seen in the electronic devices of the other players. The next player can choose to continue placing letters using the ones already placed by the previous player or can choose to place their letters in a different configuration in the same square or sub-region as the first player or in a different square or sub-region altogether. Play continues in this manner, where players can see the results on their screen of the letters that other players have placed if their placement is the same. Otherwise they can see only their own placements. The winner of the round is the first player to successfully complete the puzzle.

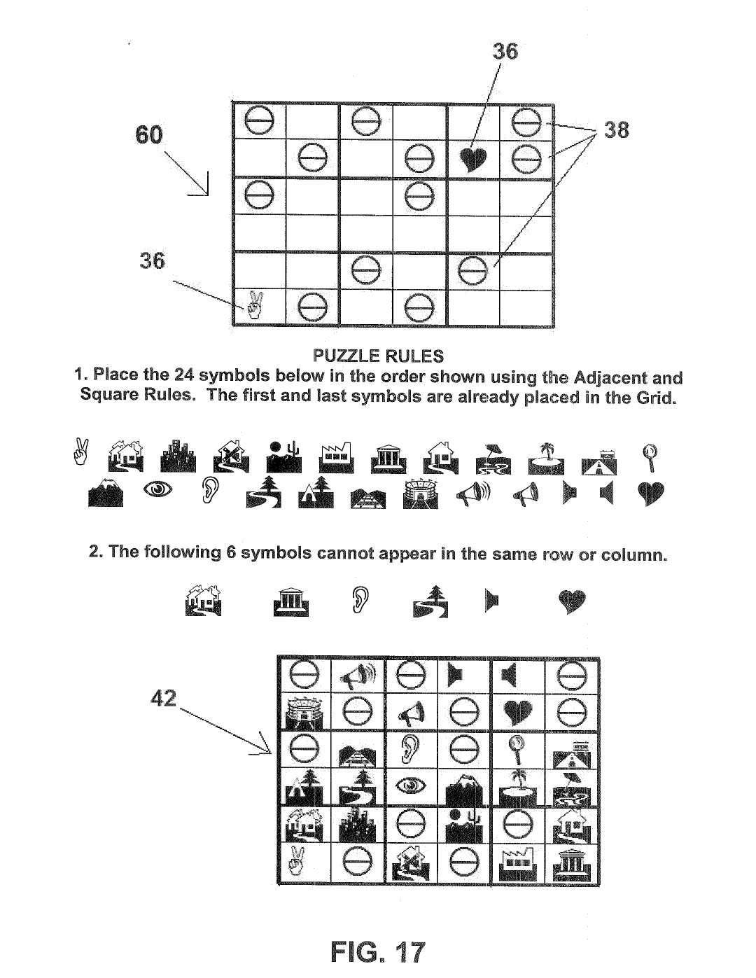

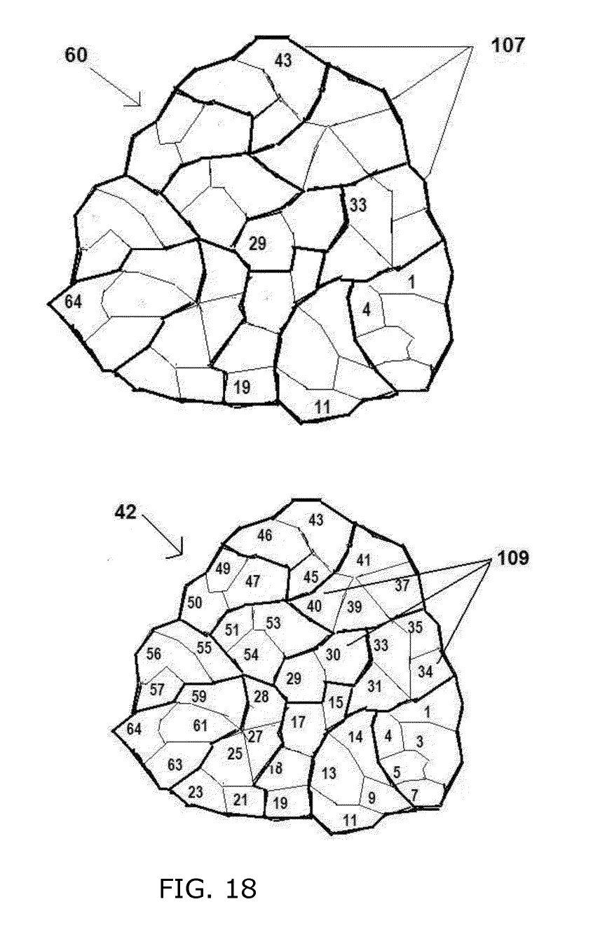

FIG. 17 shows an embodiment of the puzzle 60 that consists of a puzzle using symbols rather than letters or numbers. The order of the symbols is given as well as a list of the six symbols that are considered special symbols. There is a modified vowel rule that requires that in a correct solution of the puzzle only one of these special symbols may appear in any row or column of the grid.

There is also a special symbol that is used to indicate the blanked out cells 38 in the grid. Since this puzzle uses twenty-four symbols, there are twelve blanked out cells in the thirty-six cell grid shown. There are two given symbols 36, which in this embodiment are the first and last symbols in the ordered list of symbols.

The solution 42 to the puzzle is shown. One can check that this solution conforms to the standard puzzle rules, the adjacent, given, square and modified vowel rule, using methods similar to that shown above.

As with other embodiments of the puzzle invention, this embodiment or other embodiments that use symbols rather than letters or numbers can also be used, using an electronic devise, puzzle kit or game kit as described above, in one of the game embodiments described or in any other game embodiment that falls within the scope of this puzzle or game invention.

FIG. 18 shows an embodiment of the puzzle invention using a set of numbers, which has the property that its twelve special sub-regions are not of uniform size and shape. Three of the twelve special sub-regions, which are set off by bolder border lines, are indicated 107. The rules are shown below.

### Rules for a Puzzle With Non-Uniform Special Regions

The object is to complete the grid shown below by placing each of the numbers in the list below in order, starting with the number 1, placing one number in each cell, while following all of the four rules listed below. Note that special sub-regions are set off by the bolder border lines.
Rule 1: Each new number listed must be either next to, directly above, directly below or on a diagonal that is adjacent with the previous number. [ADJACENT RULE]
Rule 2: Numbers are already filled in that you must use. [GIVEN RULE]
Rule 3: When filling in successive numbers, once you place a number in a special sub-region, you must finish filling in that sub-region before placing a number in a new special sub-region. [MODIFIED SQUARE RULE]
Rule 4: When all the numbers are filled in, the even number must be placed so that no two even numbers are in the same sub-region and so that exactly one number is in each sub-region. [MODIFIED EVEN RULE]

### NUMBER LIST: 1 3 4 5 7 9 11 13 14 15 17 18 19 21 23 25 27 28 29 30 31 33 34 35 37 39 40 41 43 45 46 47 49 50 51 53 54 55 56 57 59 61 63 64

The rules consist of the Adjacent Rule, Given Rule, Modified Square Rule, which is related to the special sub-regions, and the Even Rule, which explains the requirements for the even numbers that are given in the list of numbers to be used for this puzzle. In this rule, exactly one even number is to be placed in each special sub-region. Also, unlike most of the other embodiments shown so far, there are no Blanked Out cells. Notice that in another variation of this puzzle embodiment there is an additional Rule 5: No two even numbers can be adjacent to each other. [ADJACENT EVEN RULE]

The solution 42 to the puzzle of FIG. 18 is also shown in FIG. 18. Notice that three of the even numbers 109, out of a total of twelve even numbers in the number list, are shown. In some versions of this and other puzzles shown, as well as ones not shown, the solution may be unique. In other cases there may be multiple correct solutions. The puzzle grid in other embodiments can be a different size and shape, use a different set of numbers and have a different subset of special numbers. All of the above mentioned variations fall with the scope of this puzzle invention. Moreover, game embodiments associated with these aforementioned embodiments also fall within the scope of this game invention.

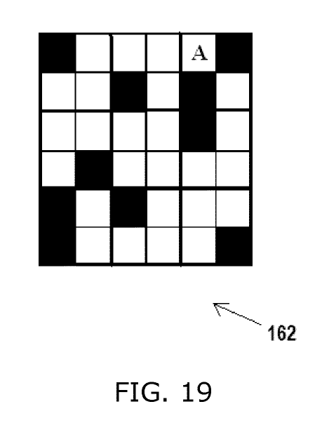

FIG. 19 shows one embodiment of a game based on one of the embodiments of the puzzle invention. This game can be played using a tray such as that depicted in FIG. 4 or on a metal game board with magnetic puzzle pieces or on card stock or white boards using writing devices such as pencils or white board markers. The game rules are listed below and an example of a puzzle board 162 is shown.

### Game Rules

1. The game is played with 2-4 players. A puzzle board is chosen at random from one of the categories—Easy, Medium or Difficult.
2. Players each toss a die to decide who goes first. The person with the highest score goes first. Play proceeds clockwise among the players.
3. Each player takes a turn in attempting to solve the puzzle using the four basic rules: Adjacent, Given, Square and Vowel rules. (see FIG. 2)
4. When a player reaches a ‘dead end’ they receive a score equal to the number of letters they have successfully placed.
5. Play continues with each player taking one or more turns attempting to complete the puzzle until one player successfully completes the puzzle. The player who successfully completes the puzzle receives an extra ten points.
6. Once one puzzle is completed a new puzzle board is chosen at random and the player with the lowest cumulative score can decide whether or not they want to go first.
7. The game ends when either a predetermined number of puzzle boards are completed or when a predetermined score (ex. 100) is reached by one of the players.

In another version of a two or more player game, a game board or game template is provided in which each player has their own puzzle to complete within the same game board so that the respective puzzles interconnect or interlock. A turn by one player would be considered completed if one of the following events occurred: one player successfully completing a puzzle or one player having been ‘blocked.’ Play would then proceed to the next player, who attempts to place as many letters as possible on his or her interlocking puzzle. Points are awarded to players based on various events such as ‘blocking’ another player or causing another player to be blocked one or more times, or placing more letters than another player on the game board or completing their own puzzle. The ‘round’ of the game is considered finished when all players are blocked or at least one player has completed their puzzle. Respective scores are tallied at the end of each round. The winner of the game is the player who reaches a predetermined score, or the player who has the highest score after a predetermined number of rounds are played.

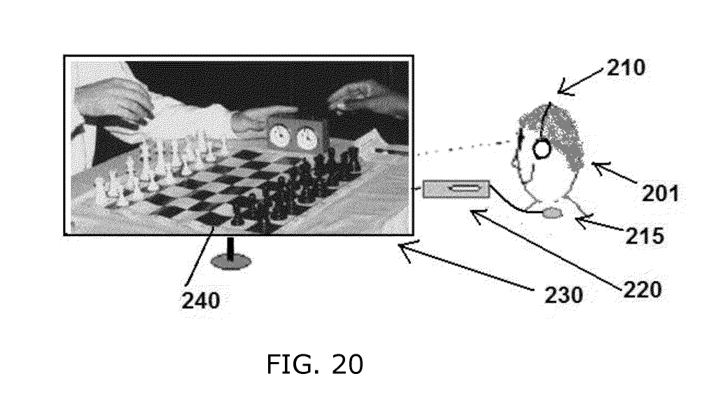

FIG. 20 illustrates my invention that comprises a method that is intended for teaching and promoting chess improvement but that can be used with any type of learning content. A person, the learner, 201 listens to a program of audio content with the option of using a headphone or similar device 210 that is connected to a DVD player or similar device 220, while having the option in one embodiment of viewing content on a TV monitor 230 or similar device whose visual content 240 is associated with the audio content. In one embodiment, there is a biofeedback device 215 that monitors the psycho-physical state of the learner. The biofeedback device can be one or a series of skin patches or a monitor connected to ones finger or other appendage. The intention is that the monitor detects through various means that are well known, when the learner has attained a deeply relaxed state. This deeply relaxed state is known to be one that is most conducive to subliminal learning.

What makes this method unique is the content of the audio-visual program, which comprises audio and in one embodiment optional related video content, wherein the intent of the initial audio instructions is to induce a deeply relaxed mental and physical state for the listener. Once this deeply relaxed state is achieved, the biofeedback monitoring device detects this deeply relaxed state of the listener/viewer. At this point in time the monitor then sends an electronic signal to the audio-visual player to change to a new track or chapter that is contained in the audio-visual storage device. In one embodiment of this invention, the audio-visual content comprises chess principles, guidelines and hints along with visual material that is related to the audio material. The details relating to the game of chess are described below.

Of course it is possible to have audio-visual content related to any subject, in which it is desired to learn or memorize material content. This content is spoken in a manner that maximizes the potential for the user to mentally internalize the content. In one embodiment there is also video content that is coordinated with the audio content, while in other embodiments there is only audio content.

The intention of all the embodiments of this method is that the user of this program will be able to learn any material that is prerecorded onto the audio and in some embodiments the visual storage and delivery device. In one embodiment the intention is to teach the learner to make more informed and accurate decisions during a game of chess.

In particular after the user makes repeated use of any embodiment of this chess program, the user will be able to easily access from their subconscious exactly the information from the program that is needed in order to make an informed and accurate decision about the chess position under consideration. For example, one principle in the program states: In all phases of the game pay attention to your opponent's threats and intentions. Another principle states: Check every check and examine its consequences. While the player who has used this program a number of times is examining a particular chess position, that player may recall and use the above two principles in order to discover that their opponent is planning a check that would give their opponent a significant advantage. Because the information in the principles has been internalized by the user of the program, the player will be able to successfully recognize the threatened check and take action to respond appropriately.

Another part of the method relates directly to the puzzle invention. Most of the embodiments of this puzzle involve a method of thinking that is similar to a method of thinking in chess. The method in chess involves examining a chess position, evaluating the key characteristics of the position and then using the resulting information to choose two to four candidate moves. These candidate moves will then be used as the basis for a further analysis of the position and for choosing the best of the candidate moves, that is, the move that the player finally makes in the game. While playing a game of chess many master chess players construct mentally what is known as an analysis tree, which involves looking for the most likely response for each of the candidate moves, while continuing to examine moves and opponent's responses several moves forward. Each such string of moves is known as a branch in the analysis tree. At a certain point the position at the end of each branch is evaluated, using criteria such as that provided in the audio-visual program described above. The player then chooses the one move that appears to be the best move, based on a comparison of the evaluations of the respective positions at the end of each branch.

The candidate move and tree analysis process are not only difficult to carry out, but difficult to explain and teach, especially to younger students of chess. The basic elements of the process are very similar to those that one carries out when making a decision about a placement of a letter in many embodiments of the puzzle invention.

One example is provided in the process described for choosing the placement of the letter A in the detailed description above for the puzzle in FIG. 2 and FIG. 3. By examining the characteristics and considering how one would solve that particular puzzle, one would likely conclude that there are only two possible choices for the placement of the letter A. In other words, if one decides to begin solving the puzzle with the placement of the letter A, then there are two candidate moves, namely placing the letter A to the left of or above the letter B that is already in the puzzle as a given letter. Once it is realized that there are only two candidate moves, one next would need to make an evaluation of the string of placements that would occur after each candidate. Looking at the candidate consisting of placing the letter A to the left of the letter B leads to one branch of the analysis tree alluded to above.

The detailed description of FIG. 3 includes an analysis that concludes that placing the letter A to the left of letter B eventually leads to a contradiction of the puzzle rules, in other words at some point the placement of letters will be blocked 41. Essentially the detailed reasoning follows along a branch of the tree that leads to a problem when one reaches the letter N. By the process of elimination, the puzzle solver then concludes that they must try the other candidate move, in this case placing the letter A above the letter B as shown in 43.

Since there are no other candidates, the puzzle solver would place the letter A above the letter B and proceed through the alphabet with letter placements until another situation is reached where there is more than one choice for letter placement. By examining the partial solution 43 in FIG. 3, one can see that the next somewhat problematical choice is after the letter F is placed. The puzzle solver then has four possible cells in which to place the letter G. The solver would immediately eliminate placing the letter G immediately to the right of the letter F as that square already contains the letter N, thus leading to a contradiction of the puzzle rules. This leaves three candidate placements, all of these below the letter F. One may likely begin by examining the branches that stem from placing the letter G directly below the letter F and diagonally to the left of the letter F. Projecting forward from each of these two branches one would soon see that each of these branches leads to a violation of the vowel rule. The letter I in the lower right square will end up on the same column as either the letter A or the letter E. Therefore the only candidate placement left, placing the letter G diagonally to the right of the letter F, must be the correct placement. Placements for the rest of the letters would continue using the same type of reasoning method.

It is worth mentioning parenthetically that after one solves a number of these types of puzzles other principles and strategies become apparent. For example in the embodiment of the puzzle just discussed, if there is a row or column that has nine or more available cells, then the first nine letters cannot all be placed in that row or column because this action will lead to a violation of the vowel rule.

Clearly the candidate move method and the tree analysis process are easier to explain in the context of the puzzle invention. One of the reasons for this is that in the puzzle, the evaluation at the end of a branch is a finite binary operation. On the other hand the evaluation of a chess position involves a continuum rather than a binary operation.

In the puzzle a candidate move either leads eventually to a solution to the puzzle or to a dead end. There is no other possibility. In chess, there is the difficulty in even identifying the appropriate end to a branch, and there is the distinct possibility that there is no end to a branch of chess moves. If a particular move does not lead to checkmate, the player evaluating a branch must often choose to end a branch based on arbitrary criteria. The situation is also complicated by the fact that a game of chess as well as a branch in an analysis tree can result in a draw.

For all of the above reasons, there are many advantages for using the method described above of using one or more embodiments of the puzzle invention to explain and teach the candidate move and tree analysis processes.

In the puzzle invention described above, a method was described that can be used to find the correct placement of the next letter, number or symbol in a sequence. Since there are usually only a few possible cells to choose from, the cell choices are like “candidate moves” in a game of chess. One can calculate up to a certain point the consequences of each cell choice, often with exacting accuracy. Since the puzzle invention is much simpler than chess, the student of chess can more easily see how the application of the candidate move method and analysis tree works in solving the puzzle. The chess student's knowledge of the candidate move method, once understood, can then be more easily transferred to its use in choosing a chess move.

Here is a detailed description of the invention as it relates to teaching chess. This invention is a method to be used to teach general chess principles that are particularly useful in choosing moves and in the evaluation of a chess position. To implement this method this invention consists of a list of chess principles, guidelines and hints that are recorded onto a CD or similar recording storage device. There are hundreds of such chess principles, guidelines and hints, many of which are codified in chess books.

The CD or other recording contains two parts. The first part consists of a monologue that helps the chess student achieve a deeply relaxed state, thus preparing the student to be in a mental state that is more conducive to mentally absorbing and remembering the chess content. Monologues of this type, often accompanied by music and sounds of nature have been available for several decades. The second part of this method is unique in that it comprises of the chess material that includes the chess principles, guidelines and hints that are used by chess players to help them evaluate chess positions and to choose chess moves. For practical purposes the master chess player not only routinely uses the chess material mentioned, but must also concretely evaluate each position and calculate the consequences of each candidate move.

The method includes the process of the chess student listening to this CD or other recording while in a relaxed state. The intention of this method is that repeated listening to this material will facilitate the mental absorption of the material in a way that allows the chess student mental access to the chess principles, guidelines and hints that are most appropriate for the particular chess position under consideration during a chess game.

Further, a DVD can be devised and manufactured wherein the chess student listens to instructions and can see the instructions being carried out visually on a chessboard, where the position and moves on the chessboard correspond to the instructions being listened to. All of the above can take place while the chess student may be in a deeply relaxed mental state that is induced by material on the CD, DVD or other multi-media device.

The combined methods consist of any combination of the following:
1) a chess student being taught one or more of the above described puzzle inventions, applying the candidate move method to the solution of the puzzle and then of transferring this method to the application of the candidate move method in choosing a chess move,
2) a chess student learning the chess principles, guidelines and hints used to evaluate a position and choose moves, these being learned through the use of the CD, DVD, or other multi-media device as described above, and
3) a chess student learning the chess principles, guidelines and hints using a DVD or other multi-media device that contains visual images and cues, such as actual chess positions and an animated movie of the actual moves played, these positions and images corresponding to the instructions, or chess principles, guidelines and hints being spoken on the multi-media device.
In all of the above cases, the instructions may be listened to or watched interactively while the chess student may be in an induced deeply relaxed mental state.

Although particular embodiments of the present inventions have been described and illustrated herein, it should be recognized that modifications and variations may readily occur to those skilled in the art and that such modifications and variations may be made without departing from the spirit and scope of our inventions. Consequently, our inventions as claimed may be practiced otherwise than as specifically described above.

What is claimed is:

1. A puzzle comprising:
a grid of desired shape and size on a writing surface or on a plurality of surfaces or on an electronic display device, said grid further comprising a plurality of interconnected closed regions or cells;
a set of specified symbols, said symbols being placed in the cells in a manner such that one symbol is placed in each empty cell by a solver of said puzzle;
a set of rules that specify constraints concerning the placement of said symbols, wherein said solver of said puzzle is expected to deduce from said set of rules that a specific placement of said specified symbols constitutes a solution to said puzzle, while other placements of said symbols are construed not to be solutions, thus providing a mental challenge to said solver of said puzzle.

2. The puzzle according to claim 1, further comprising characteristics, constraints or additional rules that include one or a combination of any of:
a. means for designating certain contiguous groups or subsets of said cells of said puzzle grid as specific sub-regions of said grid, wherein said sub-regions may or may not be uniform or similar to each other in size and shape;
b. one or more blanked out cells of said puzzle grid being designated as special cells that are unavailable for placement of said symbols for the purposes of said puzzle;
c. said set of specified symbols having the characteristic of comprising an ordered set for the purposes of said puzzle;
d. said set of specified symbols having the characteristic of containing a subset of symbols that are designated as special symbols for the purpose of said puzzle;
e. said additional rules or constraints for said puzzle requiring that each member of said set of symbols be placed in said grid exactly once or some designated finite number of times for the purposes of solving said puzzle;
f. in the case that said set of symbols is an ordered set as in c. above, there is a constraint that in the process of placing said symbols in said grid for the purpose of solving said puzzle, when said puzzle is completed, once a first member of said set is placed in a cell, each succeeding symbol in said ordered set is placed in a cell that is adjacent to the cell of the previous symbol, wherein a term adjacent is defined by designating only horizontal and vertical contiguity with the previous cell, or said term adjacent is defined to also include diagonal contiguity or any other more general contiguity;
g. in the case that said puzzle grid comprises sub-regions as in a. above and that the set of symbols is an ordered set as in c. above, there is sub-region rule that once a symbol is placed in a specified sub-region that all available cells in that sub-region must be filled in before beginning to fill in the next sub-region;
h. in the case that said set of symbols contains a subset of special symbols as in d. above, said puzzle contains a restriction rule that restricts placement of said symbols, including a rule that requires that in the case that said grid of said puzzle contains rows or columns or diagonals that it is required that a specified number of special symbols may appear in said row, column or diagonal, or that there be a limit to the number of members of said special set appear in said rows, columns, or diagonals;
i. in the case that said puzzle comprises sub-regions as in a. above, a limiting rule that no more than one of said special symbols, said one of said special symbols described in d. above, be placed in each sub-region or another limiting rule that requires that exactly one special symbol be placed in each said sub-region;
j. prior to the start of the process of solving a specific example of said puzzle, said puzzle having predetermined placements in certain specific cells of none, or one or more Given Symbols from said set of symbols that are permanently placed in the grid for the purposes of that specific example of the puzzle, said symbols being required to be incorporated into the solution of said puzzle or be associated with some other constraint specified by said rules of said puzzle;
k. a constraint that when the correct solution to said puzzle is completed, said solution contains one or a plurality of specified subsets of said symbols in specified Ordered Subsets, wherein when said Ordered Subsets are in the form of letters, a word, a word abbreviation, or a plurality of words is spelled and when said Ordered Subsets are in the form of numbers, one or a plurality of specific numbers containing a plurality of digits, or when said Ordered Subsets are in the form of predetermined special symbols, an arranged order of said special symbols is presented, wherein said Ordered Subsets is indicated explicitly to the puzzle solver at the start of the puzzle solving process, or indicated implicitly by one or more “clues” given at the start of the puzzle, said clues indicating either a word, number or other said Ordered Subset, provided for the solution of said puzzle;
l. a frequency of placement rule that specifies explicit frequencies of placement for each symbol in said set of symbols, or in said subset of special symbols, placed in said grid of said puzzle in order to constitute a solution to said puzzle;
m. in the case that a set of symbols is placed a plurality of times in order to solve an example of said puzzle, as described e. or l. above, a symbol relationship rule that requires specific relationships between the symbols;
n. in the case that an example of said puzzle has associated with it more than one solution, a solution identification rule that requires said puzzle solver to find or identify all possible solutions; and
o. a starting or ending point rule requiring that a specific cell or sub-region be designated the starting point for said puzzle or a specific cell or sub-region be designated the ending point for an example of said puzzle, wherein the starting and ending points are contiguous with or are on the outer border of the puzzle grid, or one of said starting and ending points is on the border and the other is not on the border, with a description and process similar to the solving of a maze.

3. The puzzle according to claim 2, wherein said puzzle solver of said puzzle is provided with a set or a plurality of sets of instructions for solving said puzzle, with the intention that said puzzle solver attempts to solve said puzzle by means of a writing surface or plurality of writing surfaces, said surfaces being one of erasable or non-erasable, using appropriate writing implements.

4. The puzzle according to claim 2, wherein said puzzle solver of said puzzle is provided with a puzzle kit, wherein said puzzle solver attempts to solve said puzzle by means of said kit, said kit comprising one or any combination of the following parts, characteristics, rules or constraints,
a container for said parts of said puzzle kit;
said parts comprising a set of tiles wherein each said tiles contains imprinted or otherwise displayed on said tiles the letters, numbers or symbols for said puzzle;
a tray that comprises a flat container with sides that comprise partitions or compartments corresponding to said cells of said puzzle grid, said tray designed so that said tiles fit conveniently into said tray, one tile per each grid compartment;
a set of puzzle pages constructed of predetermined suitable material and of appropriate size to fit into the bottom of said tray, wherein one or more examples of a puzzle template is printed on each said puzzle page;
said tray being constructed to include means for inserting said puzzle page so that a single puzzle page is inserted into the bottom of said tray in a way that allows said puzzle grid to be visible to said puzzle solver, thus providing a means for the puzzle solver to solve a plurality of examples of said puzzles;
a set or a plurality of sets of instructions for solving said puzzles; and
means for viewing correct solutions and hints for solving said puzzles comprising a booklet, with solutions or suggestions for solutions, or a list of internet web page addresses that contain solutions or partial solutions and hints for solving said puzzles, with the intention that said solver uses said booklet or web pages either to verify attempted solutions or in order to obtain hints on how to proceed to obtain or discover a solution to one or a plurality of specific examples of said puzzle.

5. The puzzle according to claim 2, wherein said puzzle solver of said puzzle is provided with a set or a plurality of sets of instructions for solving said puzzle, with the intention that said solver attempts to solve said puzzle by means of an electronic device, said electronic device comprising one or any combination of a digital display screen, a contact sensitive display screen, a set of user controls adjacent to a display surface, said electronic device employing digital hardware and preprogrammed software available through an electronic network, an installed piece of software that is accessible using a desktop computer, laptop computer, PDA, music player, cellular phone, gaming device or other stationary, portable, wearable or hand-held electronic device that contains one or more of a viewable display surface, employed digital hardware and preprogrammed software that detects tilting, rotation and other gestures of said electronic device so that said puzzle can be solved by moving a virtual image that is moved by the user from cell to cell on said viewable display surface of said electronic device by either a set of controls that are located on or are connected by some electronic means to the device, the user tilting, rotating or otherwise physically moving said electronic device, said device having software programmed so that the appropriate letter of the alphabet or number or other symbol lights up or becomes visible when said virtual image passes through a cell in said grid, that are partially or fully controlled by the user of said electronic device using an electronic function menu associated with said electronic device, allowing said device to notify the user when a correct solution or partial solution to said puzzle is completed, or a means for providing hints as to the correct direction for said virtual image, or means for providing indications that indicate to the user when said solver should attempt a different placement of said letter, number or symbol, or a different movement of said virtual image on said viewable surface in order to arrive at a correct solution of said puzzle, said indications being provided by sensual perception means including any combination of indicator lights, flashing lights, changing colors, various sounds, or vibrations so that sensations enabled and detected by user of said electronic device may be felt, heard or observed by the user, said sensations meant to indicate a particular stage in the puzzle solving process or meant to indicate a particular movement of said electronic device or in order to indicate a particular feedback message to said puzzle solver concerning an attempt at a solution to said puzzle.

6. The puzzle according to claim 2, wherein said puzzle solver of said puzzle is provided with a set or a plurality of sets of instructions for solving said puzzle, with the intention that said solver attempts to solve said puzzle by means of manipulating one or a plurality of three-dimensional objects that fit together in a proscribed manner, wherein one or a plurality of the surfaces of said three dimensional object or objects has inscribed thereon letters, numbers or symbols, and wherein said object or objects are manipulated so that the solver of said puzzle attempts to arrange the three-dimensional object or objects in accordance with said set of rules, wherein said letters, numbers or symbols inscribed on said surfaces of said three-dimensional object or objects form a solution in accordance with said set of rules.

7. The puzzle according to claim 2, wherein said puzzle is in the form of a game incorporating said puzzle or a set puzzles which is played by two or more players that comprises a competition for solving said puzzle or set of puzzles, said game including a game kit comprising any one or any combination of predetermined game components, rules, constraints, goals and elements:
a set of said puzzle grids wherein at the start of each game, said puzzle grids being permanently printed on a writing surface or stored electronically in a file as a Puzzle Template, wherein a plurality of said puzzle templates are included as part of said game kit;
means by which said puzzle templates are permanently marked if printed and contain spaces for players to place electronically on an electronic display device said letters, numbers, or symbols on said puzzle grid;
a game tray that comprises a flat container with sides that comprise partitions or compartments corresponding to said cells of said puzzle grid, said tray designed so that said tiles fit conveniently into said tray, one tile per each grid compartment;
a set of puzzle pages constructed of a suitable material and of appropriate size to fit into a bottom of said game tray, wherein one or more examples of a puzzle template is printed on each said puzzle page;
means for placing a single puzzle template within said game tray assembly wherein said puzzle template is placed so that one or a plurality of game players may view said puzzle template, in a way that allows said puzzle template to be visible to one or more said players of said game;
means for determining a utilization of one said puzzle template for each “round” of a game, said round being defined by the act of replacing one said puzzle template with another;
means for determining the order for each player to take a turn placing a letter, number or symbol into a cell of their choice, or to place a plurality of letters, numbers or symbols, ordered or non-ordered, so that one or more or a combination thereof of the set of rules or constraints as listed in said instructions is followed, such combination pre-determined and specified in written game instructions;
a specified goal or goals written in said game instructions;
means for awarding points or other award to or subtracting points from said players numerical score for achieving various “goals”;
said goals including “blocking” the next player, that is making a placement of a letter, number or symbol into a cell, or a plurality of said placements so that the next player to make a move has no possible placement of a letter, number or symbol without violating one of the puzzle rules or constraints as described in said game instructions;
means for awarding or subtracting points when said next player is “blocked” from making a move that does not violate one of the rules or constraints;
means for providing awards or lost points for placing a last letter, number or symbol that correctly completes the puzzle;
means for providing awards or lost points for being the player who correctly places certain predetermined letters, numbers, or symbols, either in predetermined special regions, or a predetermined game or non-game related event;
a constraint wherein a player of the game, as designated by said game rules is required to replace or remove one or a plurality of letters, numbers or symbols that were already placed on said puzzle template in order to construct an alternative path of letters, numbers or symbols;
means for employing a pre-specified time limit for each turn of each player, such time limit being determined by a predetermined timing devices;
means for providing a variable time limit for each player depending on some particular game situation specified in said game rules;
means for providing a cumulative time limit for the entire game for each player;
means for employing a random element that can be produced by predetermined material random generators comprising tossing coins, throwing a die or a plurality of dice, including non-cube shaped three-dimensional objects, spinning a spinner or wheel, choosing a card at random from a set of cards, using electronic means in order to determine or facilitate the placement of a letter, number or symbol in a cell, or determining the placement of a blanked out cell that is ineligible for placement of a letter, number or symbol;
means for requiring a player to skip a turn or take a second turn using said random generators or for requiring a reversal in the order that players take turns;
means for determining the completion of said game, said means explicitly enumerated in said game instructions, said means comprising one or more of: one player reaching a specified score, one or a pre-determined plurality of players having completed said puzzle, or a predetermined number of said puzzles having been completed by said game players;
means for keeping score wherein said players are awarded points based on a point value being assigned to each letter, number or symbol that is placed in accordance with said game rules;
means for determining a winner of said game, said means being determined by a pre-specified rule relating to the respective scores or amount of awards for said players or by another rule made explicit in said game instructions;
means for providing for one player to indicate an intention to double a point value of some or all of the players achieving or not achieving a desired game event; and
means wherein once one player indicates said intention to double said point value of some or all of the players achieving or not achieving a desired game event, the other players have an option to withdraw from the game round or to play on and risk the consequences of the doubling, or to add their own doubling of said point value, said number of times doubling can occur in one round being limited by a set of pre-determined written game instructions.

8. The puzzle according to claim 7, wherein said game kit further comprises:
one or a plurality of game boards, each game board comprising said puzzle grids, wherein the game kit comprises a set of said game boards and a set or a plurality of sets of said instructions for playing said game or games, said kit or game comprising a container for the parts of the game, said parts comprising a set of tiles wherein each said tile contains imprinted or otherwise displayed on said tiles the symbols comprising letters, numbers, pictures, or abstract symbols, said set of game boards constructed of suitable material and of appropriate size to fit into the bottom of said game tray, wherein one or more examples of a puzzle template is printed on each said game boards, wherein said game tray is constructed with means for inserting said game board in said game tray, one at a time, said kit or game to include a set or a plurality of sets of instructions for solving said puzzles as printed on said game boards, and outside source means for viewing solutions to said puzzles so that said player uses said solutions to verify attempted solutions or in order to obtain hints on how to proceed to obtain or discover a solution to a specific example of said puzzle as printed on said game board, with the intention that said players of said game each take turns in an attempt to solve said puzzle or plurality of puzzles, wherein any one or any combination of the game components, rules, constraints, goals and elements described in claim 7 for playing said game, scoring points, randomizing events of said game, completing said game and determining a winner of said game are incorporated into the set of instructions or plurality of instructions of said game.

9. The puzzle according to claim 7, wherein said game is played using one or a plurality of electronic devices, said devices comprising either individual hand-held devices or controllers, said devices or controllers being used to control said letters, numbers, symbols, or virtual objects on a digital display device in order to complete said puzzle or said plurality of puzzles, wherein a screen of said digital display device is used in place of the game board described in claim 7, in a manner consistent with a pre-specified set of game instructions, wherein said players competing under predetermined time constraints, either to complete said puzzle or a plurality of puzzles prior to a competing player or in a manner wherein players take turns placing letters, numbers, symbols or virtual objects in cells in said electronic puzzle grid in a manner consistent with a specified set of rules, the completion of said game and winner of said game being determined in a manner described in claim 7.

10. A game comprising a puzzle that is solved using letter, number or symbol placement on a grid, competitively played by two or more players, said game comprising:
one or any combination of predetermined game components, rules, constraints, goals and elements, wherein players of said game use a game kit, wherein said game kit comprises one or any combination of said game components, rules, constraints, goals and elements;
a set of puzzle grids wherein at a start of each game, said puzzle grids being printed on a writing surface or is stored in an electronic storage medium on an electronic device to form a puzzle template, wherein a plurality of said puzzle templates are included as part of said game kit;
said puzzle templates being permanently marked when printed and contain spaces for a player's placement electronically on an electronic display device of said letters, numbers, or symbols on said puzzle grid;
a game tray that comprises a flat container with sides that comprise partitions or compartments corresponding to cells comprising said puzzle grid, said game tray designed so that said tiles fit into said tray, one tile for each grid compartment;
a set of puzzle pages constructed of suitable material and of appropriate size to fit into the bottom of said game tray, wherein one or more examples of a puzzle template is printed on each of said puzzle page;
means for placing a single puzzle template within said game tray assembly, said single puzzle template being configured so that one or a plurality of game players may view said puzzle template, in a way that allows said puzzle template to be visible to one or more of said players of said game;
means for determining a utilization of one of said puzzle templates for each “round” of a game played, said round being defined by an act of replacing one said puzzle templates with another;
means for determining an order for each player to take a turn placing a letter, number or symbol into a desired cell of choice, or to place a plurality of ordered or non-ordered letters, numbers or symbols so that one or more or any combination of the set of rules or constraints as listed in said instructions is followed, such combination being predetermined and specified in written game instructions;
a specified goal or goals written in said game instructions;
means for awarding points to or subtracting points from said players to obtain a numerical score for achieving said goals or for being blocked or blocking from making a move that does not violate said rules or constraints;
said goals including a blocking of a next player that is making a placement of a letter, number or symbol into one of said cells, or a plurality of said placements to prevent any placement of a letter, number or symbol without violating one of said puzzle rules or constraints described in said game instructions;
one of said rules providing awards or lost points for placing the last letter, number or symbol that correctly completes the puzzle;
another of said rules providing awards or lost points for being the player who correctly places certain predetermined letters, numbers, or symbols, either in predetermined special regions, or a game related or non-game related event;
one of said constraints requiring a player of the game, as designated by said game rules to replace or remove one or a plurality of letters, numbers or symbols that were already placed on said puzzle template in order to construct an alternative path of letters, numbers or symbols;
means for employing a pre-specified time limit for each turn of each player, such time limit being determined by a timing device;
means for making said time limit variable for each player in predetermined situations specified in said game rules;
means for making said time limit cumulative for an entire game for each player when specified in sad game rules;
means for employing a random element that can be produced by a predetermined random device in order to determine the placement of a letter, number or symbol in a cell, or determine the placement of a blanked out cell that is ineligible for placement of said letter, number or symbol;
means for keeping score wherein said players are awarded points based on a point value being assigned to each letter, number or symbol that is placed in accordance with said game rules;
means for determining a completion and a winner of said game, said means explicitly enumerated in said game instructions;
means for providing for one player to indicate an intention to double a point value of some or all of the players achieving or not achieving a desired game event; and
means wherein once one player indicates said intention to double said point value of some or all of the players achieving or not achieving a desired game event, the other players have an option to withdraw from the game round or to play on and risk the consequences of the doubling, or to add their own doubling of said point value, said number of times doubling can occur in one round being limited by a set of pre-determined written game instructions.

11. The game according to claim 10, wherein said game is played using said game kit, said puzzle templates comprising a game board, each game board comprises one of said puzzle grids, said game played by two or more players, wherein the game kit comprises a set of said game boards and a set or a plurality of sets of instructions for playing said game, said kit or game comprising a container for the parts of the game, said parts comprising a set of tiles wherein each said tiles contains displayed on said tiles, symbols comprising letters, numbers, pictures, or abstract symbols to be used in said game, a game tray that includes compartments corresponding to cells comprising said puzzle grid, said game tray configured so that said tiles fit into said game tray, one tile for each grid compartment, said set of game boards constructed of suitable material and of appropriate size to fit into the bottom of said game tray, wherein one example of a puzzle template is printed on each said game boards, wherein said game tray is constructed with means for inserting said game board in said game tray, one at a time, thereby providing means for said players to take turns placing a tile containing said letter, number or symbol or a plurality of said letters, numbers or symbols in accordance with a pre-specified set of rules, said kit or game having a set or a plurality of sets of instructions for solving said puzzles printed on said game boards, and means for obtaining solutions to said puzzles so that said player may use said solutions to verify attempted solutions or in order to obtain hints on how to proceed to obtain or discover said solution to a specific example of said puzzle printed on said game board.

12. The game according to claim 10, wherein said game is played using one or a plurality of electronic devices, said devices comprising individual hand-held devices or controllers, said devices or controllers being used to control said letters, numbers, symbols, or virtual objects on a digital display device in order to complete said puzzle or a plurality of said puzzles, wherein a screen of a digital display device is used in place of the game board described in claim 10, in a manner consistent with a pre-specified set of game instructions, wherein said players competing under predetermined time constraints, either to complete said puzzle or a plurality of puzzles prior to a competing player or in a manner wherein players take turns placing letters, numbers, symbols or virtual objects in cells in said electronic puzzle grid in a manner consistent with a pre-specified set of rules, the completion of said game and winner of said game being determined in a manner as described in claim 10.

13. A method for learning a subject using a configuration of audio-visual devices that comprise:
one or any combination of components and characteristics comprising:
a collection of verbal information that is desired to be learned; a set of verbal instructions;
a set of verbal instructions accompanied by predetermined music or sounds of nature for placing a listener of said instructions into a deeply relaxed mental state;
an audio-visual storage, delivery and listening device containing said verbal instructions and information;
an audio-visual storage, delivery and listening device containing said relaxation instructions;
one or a plurality of biofeedback devices that are able to detect when a person is in said deeply relaxed mental state;
an electronic display device that contains visual images and information related to the audio material;
means for listening to said audio instructions;
means for listening to said audio information;
means for viewing said electronic display device;
means for connecting and coordinating said components, the audio-visual listening device, the biofeedback devices and the electronic display device;
means for listening to the relaxation instructions until said learner attains a deeply relaxed state, at which time the biofeedback device or devices send an electronic signal to the audio-visual devices to play said audio information; said audio information being verbalized and produced; and
said coordination to include the display of predetermined visual information and images that are coordinated with said visual information; said visual images and information being displayed.

14. The method according to claim 13, wherein the material learned relates to improvement in the playing of the game of chess.

15. The method according to claim 14, wherein said learner applies information that relates to solutions of puzzles in order to use said information to attain a better understanding of and greater skill in solving problems related to the game of chess and in choosing correct moves in particular chess positions wherein said puzzles each comprise:
a grid of desired shape and size on a surface or on a plurality of surfaces or on an electronic display device, said grid further comprising a plurality of interconnected closed regions or cells;
a set of specified symbols, said symbols being placed in the cells in a manner such that one symbol is placed in each empty cell by a solver of said puzzle;
a set of rules that specify constraints concerning the placement of said symbols, wherein said solver of said puzzle is expected to deduce from said set of rules that a specific placement of said specified symbols constitutes a solution to said puzzle, while other placements of said symbols are construed not to be solutions, thus providing a mental challenge to said solver of said puzzle.
